(19) United States
(12) Patent Application Publication
(10) Pub. No.: US 2019/0331974 A1
(43) Pub. Date: Oct. 31, 2019

(54) DISPLAY DEVICE

(71) Applicant: Sharp Kabushiki Kaisha, Sakai City, Osaka (JP)

(72) Inventors: Shige FURUTA, Sakai City (JP); Yasushi SASAKI, Sakai City (JP); Yuhichiroh MURAKAMI, Sakai City (JP); Takahiro YAMAGUCHI, Sakai City (JP); Junichi YAMADA, Sakai City (JP); Hidekazu YAMANAKA, Sakai City (JP)

(21) Appl. No.: 16/306,628

(22) PCT Filed: Aug. 1, 2017
(86) PCT No.: PCT/JP2017/027837

§ 371 Date: Dec. 3, 2018

(30) Foreign Application Priority Data
Aug. 8, 2016 (JP) 2016-155679

(51) Int. Cl. G02F 1/1362; G09G 3/36

(52) U.S. Cl. CPC G02F 1/136286; G09G 3/3677

(57) ABSTRACT

Regarding a variant-form display (typically, a display device having a shape in which a non-display region is provided between display regions), it achieves a narrower picture-frame than conventional displays. In a display device having a non-rectangular display region, sub gate drivers are provided in a region where bypass wiring lines are conventionally disposed, for example, as follows. In a display device having a right-angled U-shaped display region having two projecting portions (a left projecting portion and a right projecting portion, a sub gate driver for driving some gate bus lines disposed in the left projecting portion is provided, in a region in a recessed portion, in a vicinity of the left projecting portion, and a sub gate driver for driving some gate bus lines disposed in the right projecting portion is provided, in a region in the recessed portion, in a vicinity of the right projecting portion.

### TECHNICAL FIELD

The present invention relates to a display device, and more particularly to a display device having a display region with a shape other than rectangular (typically, a right-angled U-shaped display region).

### BACKGROUND ART

In general, a plurality of source bus lines (video signal lines) and a plurality of gate bus lines (scanning signal lines) are disposed in a display region (display unit) of a liquid crystal display device, and pixel formation portions which form pixels are provided near intersections of the source bus lines and the gate bus lines. Each pixel formation portion includes a thin film transistor (TFT) which is a switching element connected at its gate terminal to a gate bus line passing through a corresponding intersection and connected at its source terminal to a source bus line passing through the intersection; a pixel capacitance for holding a pixel voltage value; and the like. The liquid crystal display device is also provided with a gate driver (scanning signal line drive circuit) for driving the gate bus lines; and a source driver (video signal line drive circuit) for driving the source bus lines.

A conventional general liquid crystal display device has a rectangular display region. However, in recent years, the development of liquid crystal display devices having a display region with a shape other than rectangular, such as liquid crystal display devices for watch applications and liquid crystal display devices for in-vehicle applications, has progressed. Such display devices are called “variant-form displays”.

Regarding display devices for watch applications, there is one having a non-display region inside a display region. An invention related to such a display device is disclosed in, for example, Japanese Laid-Open Patent Publication No. 2008-257191. A display device disclosed in Japanese Laid-Open Patent Publication No. 2008-257191 is provided with bypass wiring lines in a part of a non-display region so that gate bus lines disposed in a display region on the left side of the non-display region and gate bus lines disposed in a display region on the right side of the non-display region can be driven by one gate driver.

In addition, in relation to the present invention, the following prior art documents are also known. Japanese Laid-Open Patent Publication No. 2008-292995 discloses a configuration in which circuit units (at least either one of gate drivers and source drivers) are arranged along the periphery of a non-rectangular display region. FIGS. 16 to 18 of Japanese Laid-Open Patent Publication No. 2002-014366 disclose examples of the arrangement of a gate driver regarding a variant-form display. Note that a configuration using bypass wiring lines is also disclosed in Japanese Laid-Open Patent Publication No. 2010-054980.

### PRIOR ART DOCUMENTS

### Patent Documents

[Patent Document 1] Japanese Laid-Open Patent

Publication No. 2008-257191

[Patent Document 2] Japanese Laid-Open Patent Publication No. 2008-292995 [Patent Document 3] Japanese Laid-Open Patent

Publication No. 2002-014366

[Patent Document 4] Japanese Laid-Open Patent Publication No. 2010-054980

### SUMMARY OF THE INVENTION

### Problems to be Solved by the Invention

Meanwhile, regarding display devices other than display devices for watch applications, too, a shape is considered in which a non-display region is provided between display regions for when attention is focused on a direction in which gate bus lines extend. For example, a display device having a right-angled U-shaped display region as viewed from the top as shown in FIG. 30 and a display device having a display region with a shape provided with a V-shaped cut portion as viewed from the top as shown in FIG. 31 are considered.

Now, regarding a display device having a right-angled U-shaped display region, a configuration for driving gate bus lines is considered. Note that it is assumed that a plurality of gate bus lines are alternately driven one by one from both left and right sides of the display region. In this case, for example, as shown in FIG. 32, there are provided a gate driver 910 that drives gate bus lines from the left side of a display region 900, and a gate driver 920 that drives gate bus lines from the right side of the display region 900. In addition, gate bus lines disposed in a projecting portion of the display region 900 which is present on the upper left side in FIG. 32 and gate bus lines disposed in a projecting portion of the display region 900 which is present on the upper right side in FIG. 32 need to be connected to each other, and for the connection, use of bypass wiring lines such as those shown in FIG. 32 is considered.

When bypass wiring lines such as those described above are used, a picture-frame for disposing the bypass wiring lines is provided in a recessed portion 940. In FIG. 32, a picture-frame region required for the bypass wiring lines is indicated by a dotted line with reference character 930. The area of such a picture-frame region 930 increases as the number of bypass wiring lines increases. Hence, depending on the number of bypass wiring lines, a desired design may not be implemented due to the increase in the area of the picture-frame region.

An object of the present invention is therefore to achieve a narrower picture-frame than those of conventional displays, regarding a variant-form display (typically, a display device having a shape in which a non-display region is provided between display regions).

### Means for Solving the Problems

A first aspect of the present invention is directed to a display device having a non-rectangular display region in which scanning signal lines are disposed, the display device including:

at least one pair of scanning signal line driving units including a first-type scanning signal line drive circuit configured to drive a relatively large number of scanning signal lines; and a second-type scanning signal line drive circuit configured to drive a relatively small number of scanning signal lines, wherein

regarding the first-type scanning signal line drive circuit and the second-type scanning signal line drive circuit in a pair,
the second-type scanning signal line drive circuit drives scanning signal lines that correspond to some of the scanning signal lines driven by the first-type scanning signal line drive circuit and that are not connected to the scanning signal lines driven by the first-type scanning signal line drive circuit, and
the first-type scanning signal line drive circuit and the second-type scanning signal line drive circuit drive the corresponding scanning signal lines at same timing, based on same timing control signals.

According to a second aspect of the present invention, in the first aspect of the present invention,

the display region includes:
a wide-width region in which scanning signal lines extending from one edge to the other edge of the display region are disposed; and
two narrow-width regions in which scanning signal lines with a length corresponding to a length of a part of a distance from one edge to the other edge of the display region are disposed, and

regarding the first-type scanning signal line drive circuit and the second-type scanning signal line drive circuit in a pair,
the first-type scanning signal line drive circuit drives the scanning signal lines disposed in the wide-width region and the scanning signal lines disposed in one of the two narrow-width regions, and
the second-type scanning signal line drive circuit drives the scanning signal lines disposed in the other one of the two narrow-width regions.

According to a third aspect of the present invention, in the second aspect of the present invention,

the second-type scanning signal line drive circuit is provided in a non-display region between the two narrow-width regions, and

a width of the second-type scanning signal line drive circuit in a direction in which the scanning signal lines extend is smaller than a width of a bypass wiring line region required when it is assumed that bypass wiring lines are disposed in the non-display region, the bypass wiring lines connecting the scanning signal lines disposed in the two narrow-width regions.

According to a fourth aspect of the present invention, in the third aspect of the present invention,

the width of the bypass wiring line region is found by a following equation:

Wr=Wg×2×Nr

where Wr represents the width of the bypass wiring line region, Wg represents a width of one bypass wiring line, and Nr represents a number of the bypass wiring lines for when it is assumed that the bypass wiring lines are disposed.

According to a fifth aspect of the present invention, in the second aspect of the present invention,

bypass wiring lines connecting some of the scanning signal lines disposed in the two narrow-width regions are disposed in a non-display region between the two narrow-width regions, and

the scanning signal lines connected to the bypass wiring lines are driven by the first-type scanning signal line drive circuit.

According to a sixth aspect of the present invention, in the fifth aspect of the present invention,

a width of a bypass wiring line region in which the bypass wiring lines are disposed is smaller than a width of the second-type scanning signal line drive circuit in a direction in which the scanning signal lines extend.

According to a seventh aspect of the present invention, in the sixth aspect of the present invention,

the width of the bypass wiring line region is found by a following equation:

Wr=Wg×2×Nr

where Wr represents the width of the bypass wiring line region, Wg represents a width of one bypass wiring line, and Nr represents a number of the bypass wiring lines disposed in the bypass wiring line region.

According to an eighth aspect of the present invention, in the second aspect of the present invention,

the timing control signals are provided to the first-type scanning signal line drive circuit and the second-type scanning signal line drive circuit in a pair, using a same signal wiring line.

According to a ninth aspect of the present invention, in the second aspect of the present invention,

the timing control signals are provided to the first-type scanning signal line drive circuit and the second-type scanning signal line drive circuit in a pair, using different signal wiring lines not passing through a non-display region between the two narrow-width regions.

According to a tenth aspect of the present invention, in the second aspect of the present invention,

scanning signal lines earlier in scanning order than the scanning signal lines disposed in the two narrow-width regions are disposed in the wide-width region, and

a scanning signal is provided as a scanning start signal to the second-type scanning signal line drive circuit, the scanning signal being outputted by the first-type scanning signal line drive circuit to a scanning signal line disposed in the wide-width region.

According to an eleventh aspect of the present invention, in the second aspect of the present invention,

the display device includes two pairs of scanning signal line driving units,

the scanning signal lines disposed in the wide-width region are alternately driven one by one by a first-type scanning signal line drive circuit included in one of the two pairs of scanning signal line driving units and a first-type scanning signal line drive circuit included in the other one of the two pairs of scanning signal line driving units,

the scanning signal lines disposed in one of the two narrow-width regions are alternately driven one by one by a first-type scanning signal line drive circuit included in one of the two pairs of scanning signal line driving units and a second-type scanning signal line drive circuit included in the other one of the two pairs of scanning signal line driving units, and

the scanning signal lines disposed in the other one of the two narrow-width regions are alternately driven one by one by a second-type scanning signal line drive circuit included in the one of the two pairs of scanning signal line driving units and a first-type scanning signal line drive circuit included in the other one of the two pairs of scanning signal line driving units.

According to a twelfth aspect of the present invention, in the second aspect of the present invention,

the display device includes a pair of scanning signal line driving units,

the scanning signal lines disposed in the wide-width region and the scanning signal lines disposed in one of the two narrow-width regions are sequentially driven one by one by the first-type scanning signal line drive circuit, and

the scanning signal lines disposed in the other one of the two narrow-width regions are sequentially driven one by one by the second-type scanning signal line drive circuit.

According to a thirteenth aspect of the present invention, in the second aspect of the present invention,

the display device includes two pairs of scanning signal line driving units,

the scanning signal lines disposed in the wide-width region are sequentially driven one by one by both of a first-type scanning signal line drive circuit included in one of the two pairs of scanning signal line driving units and a first-type scanning signal line drive circuit included in the other one of the two pairs of scanning signal line driving units,

the scanning signal lines disposed in one of the two narrow-width regions are sequentially driven one by one by both of a first-type scanning signal line drive circuit included in one of the two pairs of scanning signal line driving units and a second-type scanning signal line drive circuit included in the other one of the two pairs of scanning signal line driving units, and

the scanning signal lines disposed in the other one of the two narrow-width regions are sequentially driven one by one by both of a second-type scanning signal line drive circuit included in the one of the two pairs of scanning signal line driving units and a first-type scanning signal line drive circuit included in the other one of the two pairs of scanning signal line driving units.

According to a fourteenth aspect of the present invention, in the first aspect of the present invention,

the first-type scanning signal line drive circuit and the second-type scanning signal line drive circuit include transistors used to drive the scanning signal lines, and

in each of the scanning signal line drive circuits, the transistors have different sizes depending on wiring line loads of scanning signal lines to be driven.

### Effects of the Invention

According to the first aspect of the present invention, a display device having a non-rectangular display region can adopt a configuration in which scanning signal lines which are conventionally driven by providing bypass wiring lines are driven by the second-type scanning signal line drive circuit. Here, by providing the second-type scanning signal line drive circuit while considering the number of scanning signal lines in each region, a picture-frame region can be reduced over conventional displays.

According to the second aspect of the present invention, even if there are a large number of scanning signal lines disposed in the two narrow-width regions, the area of a picture-frame region required for a non-display region (a region where bypass wiring lines are conventionally disposed) between the two narrow-width regions can be reduced over conventional displays. As such, a display device having a display region including a wide-width region and two narrow-width regions achieves a narrower picture-frame than conventional displays.

According to the third aspect of the present invention, the area of a picture-frame region can be securely reduced compared with a configuration in which bypass wiring lines are provided.

According to the fourth aspect of the present invention, the same effect as that of the third aspect of the present invention can be obtained.

According to the fifth aspect of the present invention, by suitably combining the second-type scanning signal line drive circuit and bypass wiring lines, a narrow picture-frame can be more effectively achieved.

According to the sixth aspect of the present invention, the area of a picture-frame region can be securely reduced compared with a configuration in which only the second-type scanning signal line drive circuit is provided in a non-display region between the two narrow-width regions.

According to the seventh aspect of the present invention, the same effect as that of the sixth aspect of the present invention can be obtained.

According to the eighth aspect of the present invention, in a region around the display region, the area for the scanning signal line drive circuits can be reduced. By this, a narrow picture-frame in the region around the display region can be achieved.

According to the ninth aspect of the present invention, wiring lines for the timing control signals are not provided in the non-display region between the two narrow-width regions. Hence, a narrow picture-frame is effectively achieved in a conventional bypass wiring line region.

According to the tenth aspect of the present invention, since a wiring line for a scanning start signal to be provided to the second-type scanning signal line drive circuit is not required, a narrow picture-frame is more effectively achieved.

According to the eleventh aspect of the present invention, since scanning signals are alternately provided to a plurality of scanning signal lines one by one from one end and the other end of each scanning signal line, bias in the waveform rounding of scanning signals is suppressed.

According to the twelfth aspect of the present invention, the number of scanning signal line drive circuits can be reduced compared with a configuration in which staggered driving is adopted or a configuration in which both-side driving is adopted. Hence, a narrow picture-frame is more effectively achieved.

According to the thirteenth aspect of the present invention, a scanning signal is provided to each scanning signal line from both of one end and the other end of the scanning signal line. Hence, the waveform rounding of a scanning signal at a middle portion of each scanning signal line is suppressed.

According to the fourteenth aspect of the present invention, each scanning signal line drive circuit is provided with transistors of sizes determined depending on the wiring line loads of scanning signal lines to be driven. Hence, consistency between a wiring line load and a driving capability can be achieved. As a result, an effect of power consumption optimization and an effect of a reduction in non-uniformity of display which occurs due to a difference in scanning signal waveform caused by a difference in wiring line load can be obtained.

### BRIEF DESCRIPTION OF THE DRAWINGS

FIG. 1 is a diagram for describing the arrangement of gate drivers in a liquid crystal display device according to a first embodiment of the present invention.

FIG. 2 is a functional block diagram showing a functional configuration of the liquid crystal display device according to the first embodiment.

FIG. 3 is a circuit diagram showing a configuration of one pixel formation portion in the first embodiment.

FIG. 4 is a block diagram showing a schematic configuration of a shift register circuit forming a gate driver in the first embodiment.

FIG. 5 is a circuit diagram showing an exemplary configuration of a unit circuit included in the shift register circuit in the first embodiment.

FIG. 6 is a signal waveform diagram for describing the operation of the shift register circuit in the first embodiment.

FIG. 7 is a waveform diagram of scanning signals which are outputted from the shift register circuit in the first embodiment.

FIG. 8 is a diagram for describing a relationship between a gate driver region and a conventional bypass wiring line region in the first embodiment.

FIG. 9 is a waveform diagram of gate control signals used in the first embodiment.

FIG. 10 is a signal waveform diagram for describing a driving method in the first embodiment.

FIG. 11 is a diagram showing a first configuration of wiring lines for the gate control signals in the first embodiment.

FIG. 12 is a diagram showing a second configuration of wiring lines for the gate control signals in the first embodiment.

FIG. 13 is a diagram for describing a configuration of a first variant of the first embodiment.

FIG. 14 is a diagram for describing how to determine the number of gate bus lines driven using bypass wiring lines in the first variant of the first embodiment.

FIG. 15 is a diagram for describing a configuration of a second variant of the first embodiment.

FIG. 16 is a diagram for describing a configuration of a third variant of the first embodiment.

FIG. 17 is a diagram for describing a configuration of a fourth variant of the first embodiment.

FIG. 18 is a diagram for describing a configuration of a fifth variant of the first embodiment.

FIG. 19 is a diagram for describing a configuration of a sixth variant of the first embodiment.

FIG. 20 is a diagram for describing a configuration of a seventh variant of the first embodiment.

FIG. 21 is a diagram for describing a configuration of an eighth variant of the first embodiment.

FIG. 22 is a diagram for describing the arrangement of gate drivers in a liquid crystal display device according to a second embodiment of the present invention.

FIG. 23 is a waveform diagram of gate control signals used in the second embodiment.

FIG. 24 is a signal waveform diagram for describing a driving method in the second embodiment.

FIG. 25 is a diagram for describing a configuration of a first variant of the second embodiment.

FIG. 26 is a diagram for describing a configuration of a second variant of the second embodiment.

FIG. 27 is a diagram for describing a configuration of a third variant of the second embodiment.

FIG. 28 is a diagram for describing the arrangement of gate drivers in a liquid crystal display device according to a third embodiment of the present invention.

FIG. 29 is a signal waveform diagram for describing a driving method in the third embodiment.

FIG. 30 is a diagram for describing a display device having a right-angled U-shaped display region as viewed from the top, regarding conventional art.

FIG. 31 is a diagram for describing a display device having a display region with a shape provided with a V-shaped cut portion as viewed from the top, regarding conventional art.

FIG. 32 is a diagram for describing a configuration for driving gate bus lines, regarding a conventional display device having a right-angled U-shaped display region.

### MODES FOR CARRYING OUT THE INVENTION

Embodiments of the present invention will be described below with reference to the accompanying drawings.

### 1. First Embodiment

<1.1 Overall Configuration and Overview of Operation>

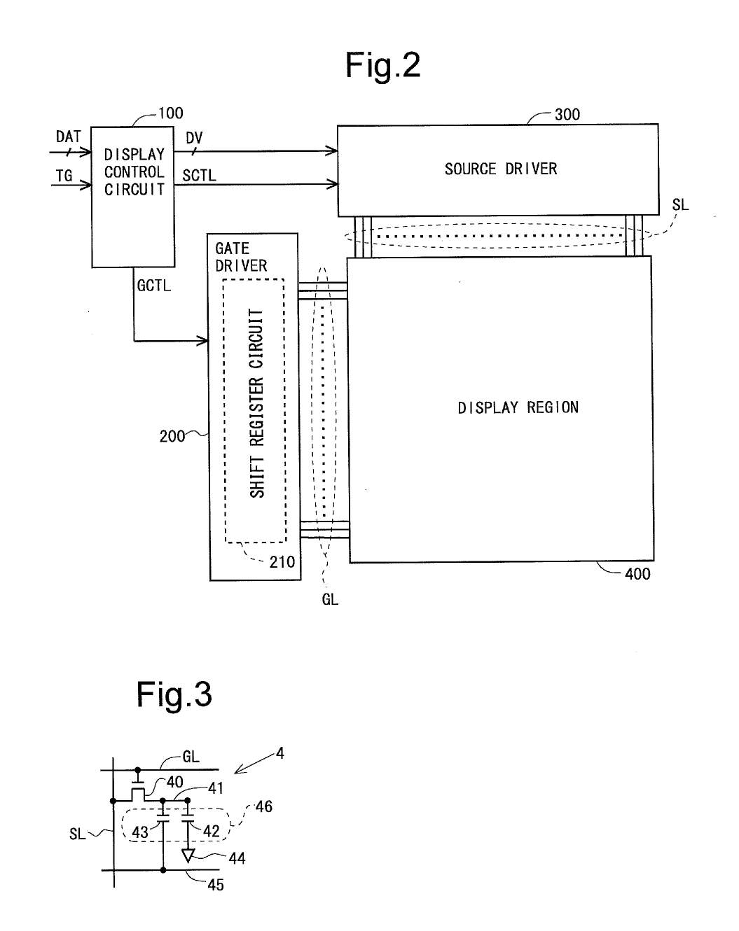

FIG. 2 is a functional block diagram showing a functional configuration of a liquid crystal display device according to a first embodiment of the present invention. As shown in FIG. 2, the liquid crystal display device functionally includes a display control circuit 100, a gate driver (scanning signal line drive circuit) 200, a source driver (video signal line drive circuit) 300, and a display region (display unit) 400. The gate driver 200 includes a shift register circuit 210. Note that FIG. 2 is a functional block diagram and does not show the actual shape and actual location of each component. Note also that the gate drivers 200 are arranged at a plurality of locations.

A plurality of source bus lines (video signal lines) SL and a plurality of gate bus lines (scanning signal lines) GL are disposed in the display region 400. In the display region 400, pixel formation portions which form pixels are provided at intersections of the source bus lines SL and the gate bus lines GL. FIG. 3 is a circuit diagram showing a configuration of one pixel formation portion 4. The pixel formation portion 4 includes a TFT (thin film transistor) 40 which is a switching element connected at its gate terminal to a gate bus line GL passing through a corresponding intersection, and connected at its source terminal to a source bus line SL passing through the intersection; a pixel electrode 41 connected to a drain terminal of the TFT 40; a common electrode 44 and an auxiliary capacitance electrode 45 which are provided so as to be shared by the plurality of pixel formation portions 4 formed in the display region 400; a liquid crystal capacitance 42 formed by the pixel electrode 41 and the common electrode 44; and an auxiliary capacitance 43 formed by the pixel electrode 41 and the auxiliary capacitance electrode 45. By the liquid crystal capacitance 42 and the auxiliary capacitance 43, a pixel capacitance 46 is formed. Note that the configuration of the pixel formation portion 4 is not limited to that shown in FIG. 3, and for example, a configuration in which the auxiliary capacitance 43 and the auxiliary capacitance electrode 45 are not provided can also be adopted.

The operation of the components shown in FIG. 2 will be described below. The display control circuit 100 receives an image signal DAT and a timing signal group TG such as a horizontal synchronizing signal and a vertical synchronizing signal, which are transmitted from an external source, and outputs digital video signals DV, gate control signals GCTL for controlling the operation of the gate driver 200, and source control signals SCTL for controlling the operation of the source driver 300. Typically, the gate control signals GCTL include a gate start pulse signal, gate clock signals, etc. In addition, typically, the source control signals SCTL include a source start pulse signal, a source clock signal, a latch strobe signal, etc.

The gate driver 200 repeats application of an active scanning signal to each gate bus line GL, based on the gate control signals GCTL outputted from the display control circuit 100, with one vertical scanning period as a cycle. Note that a detailed description of the gate driver 200 will be made later.

The source driver 300 receives the digital video signals DV and source control signals SCTL outputted from the display control circuit 100, and applies a driving video signal to each source bus line SL. At this time, the source driver 300 sequentially holds the digital video signals DV indicating voltages to be applied to the respective source bus lines SL, at timing of occurrence of pulses of the source clock signal. Then, the held digital video signals DV are converted to analog voltages at timing of occurrence of a pulse of the latch strobe signal. The converted analog voltages are simultaneously applied, as driving video signals, to all source bus lines SL.

By applying the scanning signals to the gate bus lines GL and applying the driving video signals to the source bus lines SL in the above-described manner, an image based on the image signal DAT transmitted from the external source is displayed in the display region 400.

Meanwhile, as the TFTs 40 in the display region 400, for example, an oxide TFT (a thin film transistor that uses an oxide semiconductor as a channel layer) can be adopted. More specifically, a TFT having a channel layer formed of In—Ga—Zn—O (indium gallium zinc oxide) which is an oxide semiconductor having indium (In), gallium (Ga), zinc (Zn), and oxygen (O) as the main components (hereinafter, referred to as “In—Ga—Zn—O-TFT”) can be adopted as the TFTs 40. By adopting such an In—Ga—Zn—O-TFT, effects such as an improvement in definition and a reduction in power consumption can be obtained. In addition, transistors using oxide semiconductors other than In—Ga—Zn—O (indium gallium zinc oxide) as a channel layer can also be adopted. For example, when a transistor using, as a channel layer, an oxide semiconductor containing at least one of indium, gallium, zinc, copper (Cu), silicon (Si), tin (Sn), aluminum (Al), calcium (Ca), germanium (Ge), and lead (Pb) is adopted, too, the same effects can be obtained. Note that the use of other TFTs than oxide TFTs is not excluded.

<1.2 Gate Driver>

Next, the gate driver 200 will be described in detail.

<1.2.1 Configuration and Operation of the Gate Driver>

In each embodiment, a plurality of gate drivers 200 are provided in a liquid crystal display device. Hence, first, a configuration and operation which are common to all gate drivers of all embodiments will be described. Note, however, that the configuration and operation described below are an example and the present invention is not limited thereto.

<1.2.1.1 Configuration of a Shift Register Circuit>

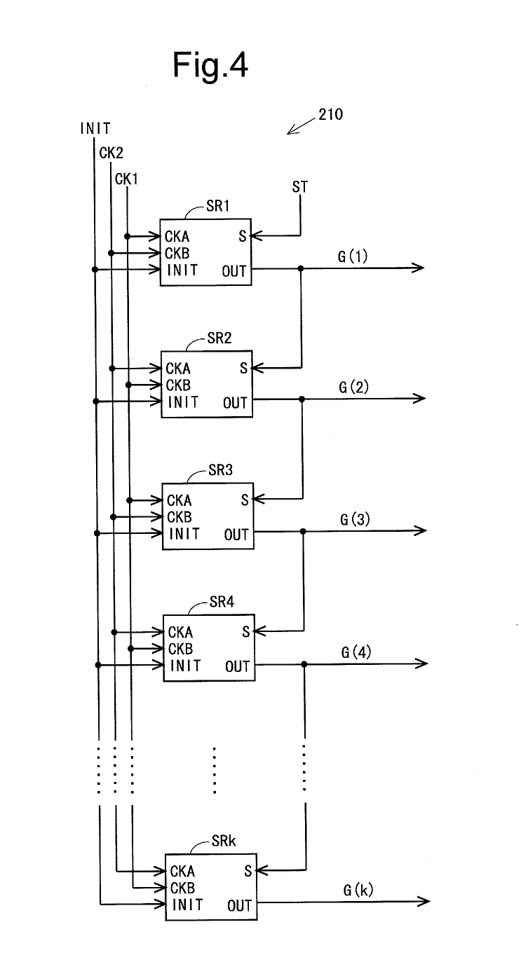

FIG. 4 is a block diagram showing a schematic configuration of the shift register circuit 210 forming the gate driver 200. The shift register circuit 210 includes k unit circuits SR1 to SRk (k is a natural number). The k unit circuits SR1 to SRk are connected in series with each other. Note that when the k unit circuits SR1 to SRk do not need to be distinguished from each other, the unit circuits are given reference character SR.

As shown in FIG. 4, each unit circuit SR is provided with an input terminal for receiving a first clock CKA; an input terminal for receiving a second clock CKB; an input terminal for receiving an initialization signal INIT; an input terminal for receiving a set signal S; and an output terminal for outputting an output signal OUT. Although each unit circuit SR is also provided with an input terminal for a low-level power supply voltage VSS and an input terminal for a high-level power supply voltage VDD, those input terminals are omitted in FIG. 4. Note that in the following the magnitude of a potential provided based on the low-level power supply voltage VSS is referred to as “VSS potential” for convenience sake. A gate start pulse signal ST, two-phase gate clock signals (a first gate clock signal CK1 and a second gate clock signal CK2), and an initialization signal INIT are provided as gate control signals GCTL to the shift register circuit 210.

Signals to be provided to the input terminals of each stage (each unit circuit SR) of the shift register circuit 210 are as follows (see FIG. 4). For odd-numbered stages, the first gate clock signal CK1 is provided as a first clock CKA, and the second gate clock signal CK2 is provided as a second clock CKB. For even-numbered stages, the second gate clock signal CK2 is provided as a first clock CKA, and the first gate clock signal CK1 is provided as a second clock CKB. Note that the first gate clock signal CK1 and the second gate clock signal CK2 are shifted in phase by 180 degrees. Note also that for any stage, an output signal OUT outputted from its previous stage is provided as a set signal S. Note, however, that for the unit circuit SR1 of the first stage, the gate start pulse signal ST is provided as a set signal S. The initialization signal INIT is provided to all stages in a shared manner.

An output signal OUT is outputted from the output terminal of each stage (each unit circuit SR) of the shift register circuit 210. An output signal OUT outputted from any stage (here, a zth stage) is provided as a scanning signal G(z) to a zth gate bus line among the k gate bus lines connected to the shift register circuit 210, and is also provided as a set signal S to a unit circuit SRz+1 of a (z+1)th stage.

In the above-described configuration, when a pulse of the gate start pulse signal ST serving as a set signal S is provided to the unit circuit SR1 of the first stage of the shift register circuit 210, shift pulses included in output signals OUT outputted from the respective unit circuits SR are sequentially transferred from the unit circuit SR1 of the first stage to the unit circuit SRk of a kth stage, based on the clock operation of the two-phase gate clock signals. Then, according to the transfer of the shift pulses, the output signals OUT outputted from the respective unit circuits SR sequentially go to a high level. By this, scanning signals G(1) to G(k) which sequentially go to a high level (active) for a predetermined period are provided to the k gate bus lines connected to the shift register circuit 210.

<1.2.1.2 Configuration of the Unit Circuit>

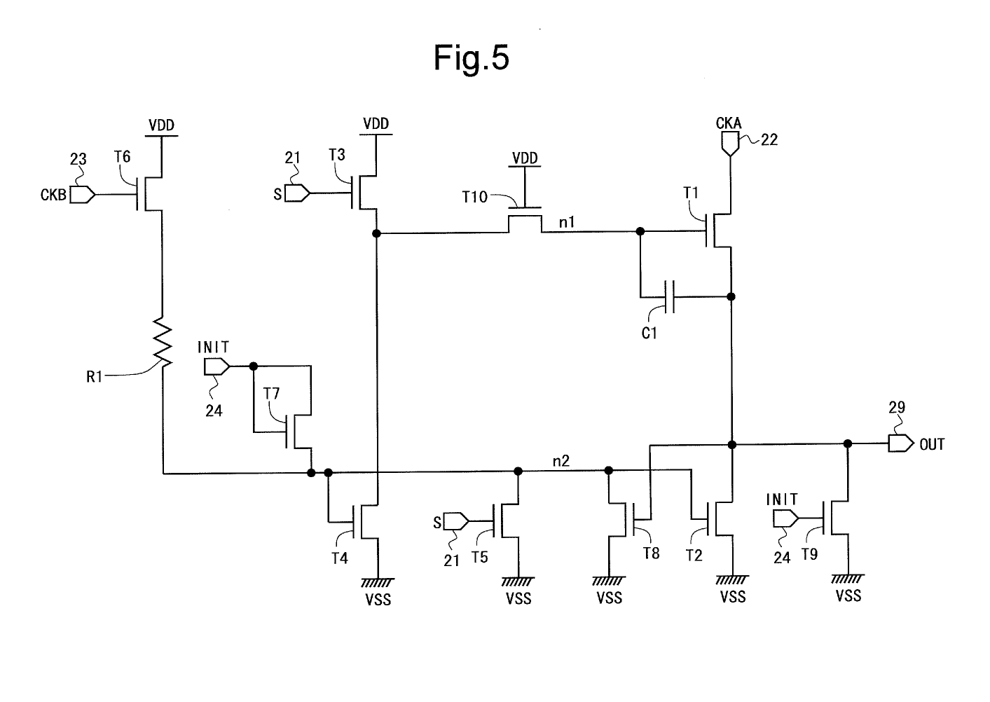

FIG. 5 is a circuit diagram showing an exemplary configuration of a unit circuit SR included in the shift register circuit 210. As shown in FIG. 5, the unit circuit SR includes 10 thin film transistors T1 to T10, one capacitor C1, and one resistor R1. In addition, the unit circuit SR has four input terminals 21 to 24 and one output terminal 29 in addition to an input terminal for a low-level power supply voltage VSS and an input terminal for a high-level power supply voltage VDD. Here, an input terminal that receives a set signal S is given reference character 21, an input terminal that receives a first clock CKA is given reference character 22, an input terminal that receives a second clock CKB is given reference character 23, and an input terminal that receives an initialization signal INIT is given reference character 24. Note that although the set signal S is provided to both of the gate terminal of the thin film transistor T3 and the gate terminal of the thin film transistor T5, FIG. 5 separately shows the input terminals 21 for the set signal S for convenience sake. Likewise, although the initialization signal INIT is provided to all of the gate terminal and drain terminal of the thin film transistor T7 and the gate terminal of the thin film transistor T9, FIG. 5 separately shows the input terminals 24 for the initialization signal INIT for convenience sake.

Next, a connection relationship between the components in the unit circuit SR will be described. The gate terminal of the thin film transistor T1, the source terminal of the thin film transistor T10, and one end of the capacitor C1 are connected to each other. Note that a region (wiring line) where they are connected to each other is referred to as “first node” for convenience sake. The first node is given reference character n1. The gate terminal of the thin film transistor T2, the gate terminal of the thin film transistor T4, the drain terminal of the thin film transistor T5, the source terminal of the thin film transistor T7, the drain terminal of the thin film transistor T8, and one end of the resistor R1 are connected to each other. Note that a region (wiring line) where they are connected to each other is referred to as “second node” for convenience sake. The second node is given reference character n2.

The thin film transistor T1 is connected at its gate terminal to the first node n1, connected at its drain terminal to the input terminal 22, and connected at its source terminal to the output terminal 29. The thin film transistor T2 is connected at its gate terminal to the second node n2, connected at its drain terminal to the output terminal 29, and connected at its source terminal to the input terminal for a low-level power supply voltage VSS. The thin film transistor T3 is connected at its gate terminal to the input terminal 21, connected at its drain terminal to the input terminal for a high-level power supply voltage VDD, and connected at its source terminal to the drain terminal of the thin film transistor 14 and the drain terminal of the thin film transistor T10. The thin film transistor T4 is connected at its gate terminal to the second node n2, connected at its drain terminal to the source terminal of the thin film transistor T3 and the drain terminal of the thin film transistor T10, and connected at its source terminal to the input terminal for a low-level power supply voltage VSS. The thin film transistor T5 is connected at its gate terminal to the input terminal 21, connected at its drain terminal to the second node n2, and connected at its source terminal to the input terminal for a low-level power supply voltage VSS.

The thin film transistor T6 is connected at its gate terminal to the input terminal 23, connected at its drain terminal to the input terminal for a high-level power supply voltage VDD, and connected at its source terminal to the other end of the resistor R1. The thin film transistor T7 is connected at its gate and drain terminals to the input terminal 24 and connected at its source terminal to the second node n2. The thin film transistor T8 is connected at its gate terminal to the output terminal 29, connected at its drain terminal to the second node n2, and connected at its source terminal to the input terminal for a low-level power supply voltage VSS. The thin film transistor T9 is connected at its gate terminal to the input terminal 24, connected at its drain terminal to the output terminal 29, and connected at its source terminal to the input terminal for a low-level power supply voltage VSS. The thin film transistor T10 is connected at its gate terminal to the input terminal for a high-level power supply voltage VDD, connected at its drain terminal to the source terminal of the thin film transistor T3 and the drain terminal of the thin film transistor 14, and connected at its source terminal to the first node n1.

The capacitor C1 is connected at its one end to the gate terminal of the thin film transistor T1 and connected at its other end to the source terminal of the thin film transistor T1. The resistor R1 is connected at its one end to the second node n2 and connected at its other end to the source terminal of the thin film transistor T6.

<1.2.1.3 Operation of the Shift Register Circuit>

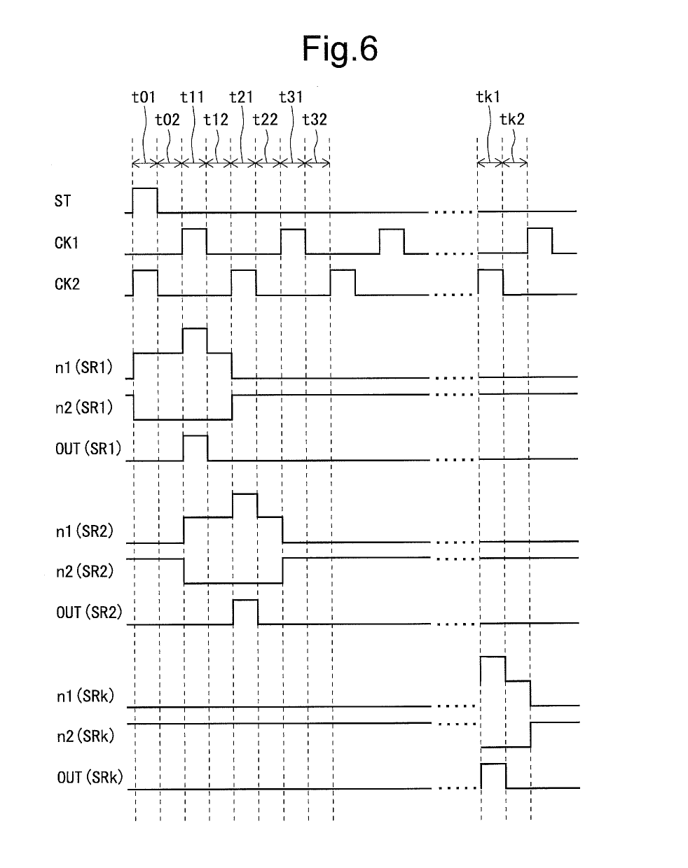

Next, with reference to FIGS. 4 to 6, the operation of the shift register circuit 210 will be described. FIG. 6 is a signal waveform diagram for describing the operation of the shift register circuit 210. Note that here operation common to all gate drivers of all embodiments is described, and thus, in FIG. 6 the pulse widths and pulse occurrence intervals of the two-phase gate clock signals (the first gate clock signal CK1 and the second gate clock signal CK2) are not shown by lengths corresponding to the actual lengths.

In FIG. 6, a period during which a pulse of the gate start pulse signal ST is to be outputted is indicated by reference character t01, and a period during which a pth gate bus line (p is an integer between 1 and k, inclusive) among the k gate bus lines connected to the shift register circuit 210 is to be placed in a selected state is indicated by reference character tp1. For example, a period during which the second gate bus line is to be placed in a selected state is indicated by reference character t21. In addition, for FIG. 6, for example, “n2(SR2)” indicates the “second node n2 in the unit circuit SR2 of the second stage”.

During a period before period t01, in all unit circuits SR, the potential of the first node n1 is at a low level, the potential of the second node n2 is at a high level, and the output signal OUT is at a low level.

First, attention is focused on the unit circuit SR1 of the first stage. During period t01, a pulse of the gate start pulse signal ST is outputted. Since the gate start pulse signal ST is provided as a set signal S to the unit circuit SR1 of the first stage, the thin film transistor T3 and the thin film transistor T5 go into an on state during period t01. By the thin film transistor T5 going into an on state, the potential of the second node n2 goes to a low level. By this, the thin film transistor T2 and the thin film transistor T4 go into an off state. In addition, at this time, the thin film transistor T10 is in an on state, and due to the thin film transistor T3 going into an on state, the first node n1 is precharged. By the precharging, the potential of the first node n1 becomes almost “VDD−Vth”. Note that Vth is a threshold voltage of the thin film transistor T3. In addition, since, as described above, the thin film transistor T4 is in the off state, the potential of the first node n1 does not decrease.

During period t11, the set signal S (gate start pulse signal ST) is at a low level. Hence, the thin film transistor T3 is in an off state. In addition, during period t11, the second gate clock signal CK2 is at a low level. Since the second gate clock signal CK2 is provided as a second clock CKB to the unit circuit SR1 of the first stage, the thin film transistor T6 is in an off state. Therefore, the second node n2 is maintained at the low level and the thin film transistor T4 is in an off state. By this, during period t11, the first node n1 is in a floating state.

In addition, during period t11, the first gate clock signal CK1 changes from a low level to a high level. Since the first gate clock signal CK1 is provided as a first clock CKA to the unit circuit SR1 of the first stage, the potential at the input terminal 22 increases during period t11. Since the first node n1 is in the floating state as described above, the first node n1 is bootstrapped (the first node n1 goes into a boosted state) by the increase in the potential at the input terminal 22. Specifically, the potential of the first node n1 becomes almost “VDD×2−Vth”. By this, a large voltage is applied to the gate terminal of the thin film transistor T1, and the potential of the output signal OUT (the potential at the output terminal 29) increases to a high-level potential of the first gate clock signal CK1 without causing a so-called threshold voltage drop (the threshold voltage drop is a phenomenon in which the source potential increases only to a potential lower by the threshold voltage than the drain potential). In this manner, the gate bus line connected to the output terminal 29 of the unit circuit SR1 of the first stage is placed in a selected state.

Furthermore, during period t11, by the output signal OUT going to a high level in the above-described manner, the thin film transistor T8 goes into an on state. By this, the potential of the second node n2 is securely drawn to the VSS potential. Therefore, during period t11, the thin film transistor T2 and the thin film transistor T4 are securely maintained in the off state. Hence, the potential of the output signal OUT and the potential of the first node n1 do not decrease during period t11.

Meanwhile, if the thin film transistor T10 is not provided in the unit circuit SR, then the source potential of the thin film transistor T3 and the drain potential of the thin film transistor T4 become an extremely high potential (almost “VDD×2−Vth”) by the bootstrapping based on the increase in the potential at the input terminal 22 during period t11. Due to this, there is a possibility that a voltage exceeding a breakdown voltage may be applied to the thin film transistor T3 and the thin film transistor T4. That is, there is a possibility that the thin film transistor T3 and the thin film transistor T4 may be destroyed.

Regarding this, according to the configuration shown in FIG. 5, since the thin film transistor T10 is provided in the unit circuit SR, even if the potential of the first node n1 is increased to “VDD×2−Vth” during period t11, the source potential of the thin film transistor T3 and the drain potential of the thin film transistor 14 are maintained at “VDD−Vth” or less. By this, the thin film transistors T3 and T4 are prevented from being destroyed.

During period t12, the first gate clock signal CK1 changes from the high level to a low level. By this, with a decrease in the potential at the input terminal 22, the potential of the output signal OUT goes to a low level. In addition, the potential of the first node n1 decreases.

During period 21, the second gate clock signal CK2 changes from the low level to a high level. By this, the thin film transistor T6 goes into an on state. As a result, the potential of the second node n2 increases to a high level from the low level through the resistor R1, and thus, the thin film transistor T2 and the thin film transistor 14 go into an on state. By this, the potential of the output signal OUT and the potential of the first node n1 are drawn to the VSS potential.

During and after period t22, in the unit circuit SR1 of the first stage, every time the second gate clock signal CK2 changes from a low level to a high level, the thin film transistor T6 goes into an on state. Therefore, during and after period t22, the potential of the second node n2 is maintained at a high level, and the potential of the output signal OUT and the potential of the first node n1 are drawn to the VSS potential whenever necessary.

Next, attention is focused on the unit circuit SR2 of the second stage. The output signal OUT outputted from the unit circuit SR1 of the first stage is provided as a set signal S to the unit circuit SR2 of the second stage. Therefore, to the unit circuit SR2 of the second stage, a high-level set signal S is provided during period t11. By this, as with the unit circuit SR1 of the first stage for period t01, the first node n1 is precharged during period t11. Then, during period t21, as with the unit circuit SR1 of the first stage for period t11, the first node n1 is bootstrapped and the potential of the output signal OUT increases to a high-level potential of the second gate clock signal CK2. In addition, during period t22, as with the unit circuit SR1 of the first stage for period t12, the potential of the output signal OUT goes to a low level and the potential of the first node n1 decreases. Furthermore, during period t31, as with the unit circuit SR1 of the first stage for period t21, the potential of the output signal OUT and the potential of the first node n1 are drawn to the VSS potential. Furthermore, during and after period t32, as with the unit circuit SR1 of the first stage for period t22 and thereafter, the potential of the output signal OUT and the potential of the first node n1 are drawn to the VSS potential whenever necessary.

The same operation is also performed for the third to kth unit circuits SR3 to SRk. Note that the initialization signal INIT is brought to a high level, for example, during a vertical flyback period. When the initialization signal INIT goes to a high level, the thin film transistor T7 and the thin film transistor T9 go into an on state. By the thin film transistor T7 going into an on state, the potential of the second node n2 goes to a high level and the thin film transistor T2 and the thin film transistor T4 go into an on state. From the above, the potential of the output signal OUT and the potential of the first node n1 are drawn to the VSS potential. Since the initialization signal INIT is provided to all unit circuits SR1 to SRk in a shared manner, by bringing the initialization signal INIT to a high level, the potential of the output signal OUT and the potential of the first node n1 can be brought to the VSS potential in all unit circuits SR1 to SRk.

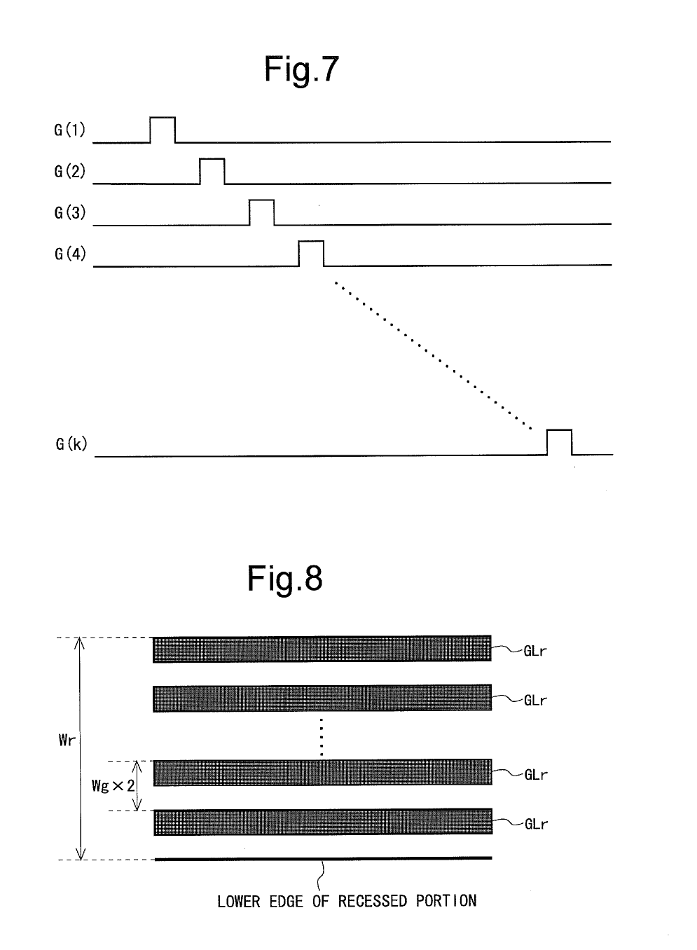

In the above-described manner, output signals OUT1 to OUTk which sequentially go to a high level for a predetermined period are outputted from the k unit circuits SR1 to SRk included in the shift register circuit 210. By this, as shown in FIG. 7, scanning signals G(1) to G(k) which sequentially go to a high level for the predetermined period are provided to the k gate bus lines connected to the k unit circuits SR1 to SRk, respectively.

<1.2.2 Arrangement of the Gate Drivers>

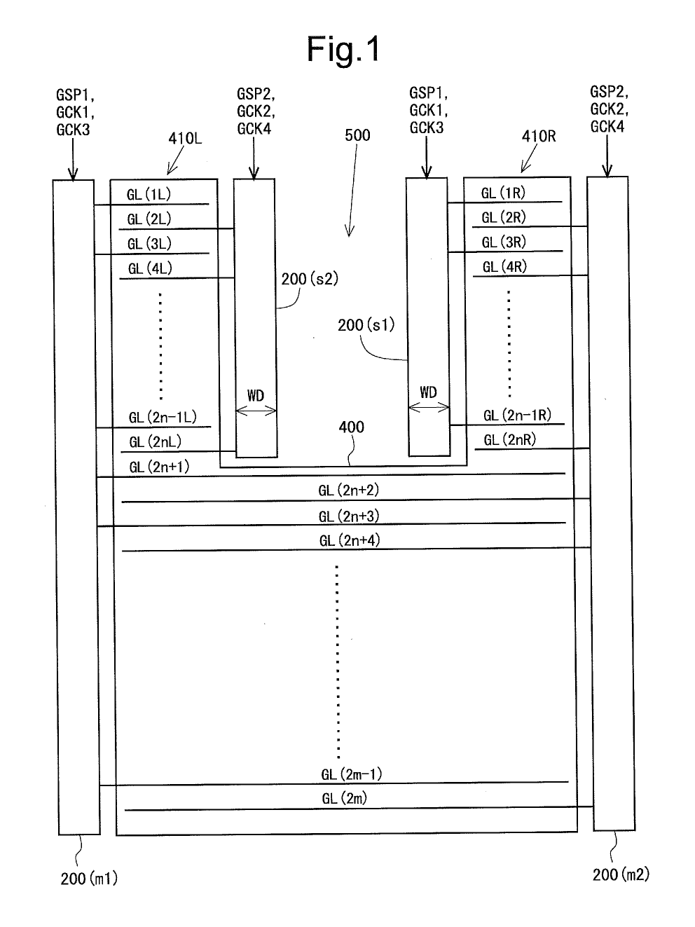

The gate drivers 200 of the present embodiment will be described below. FIG. 1 is a diagram for describing the arrangement of the gate drivers 200 of the present embodiment. In the present embodiment, unlike general display devices, the display region (display unit) 400 has a non-rectangular shape. More specifically, as can be grasped from FIG. 1, the display region 400 has a right-angled U-shape as viewed from the top. Note that in the following a projecting portion of the display region 400 present on the upper left side in FIG. 1 is referred to as “left projecting portion”, a projecting portion of the display region 400 present on the upper right side in FIG. 1 is referred to as “right projecting portion”, and a region between the left projecting portion and the right projecting portion is referred to as “recessed portion”. The left projecting portion is given reference character 410L, the right projecting portion is given reference character 410R, and the recessed portion is given reference character 500. In addition, a portion of the display region 400 other than the projecting portions (the left projecting portion 410L and the right projecting portion 410R) is referred to as “rectangular portion”. In the present embodiment, a wide-width region is implemented by the rectangular portion, and two narrow-width regions are implemented by the left projecting portion 410L and the right projecting portion 410R.

In each of the left projecting portion 410L and the right projecting portion 410R, there are disposed 2n gate bus lines (n is a natural number) (gate bus lines with a length corresponding to the length of a part of a distance from one edge to the other edge of the display region 400). In FIG. 1, the gate bus lines disposed in the left projecting portion 410L are given reference character GL(1L) to GL(2nL) and the gate bus lines disposed in the right projecting portion 410R are given reference character GL(1R) to GL(2nR). In the rectangular portion, there are disposed (2m−2n) gate bus lines (m is a natural number) (gate bus lines extending from one edge to the other edge of the display region 400). In FIG. 1, the gate bus lines disposed in the rectangular portion are given reference character GL(2n+1) to GL(2m). As an example, m is 240 and n is 120. In this case, 240 gate bus lines are disposed in each of the left projecting portion 410L and the right projecting portion 410R, and 240 gate bus lines are disposed in the rectangular portion as well.

In the present embodiment, as shown in FIG. 1, the gate drivers are arranged at four locations. In addition, the gate drivers include main gate drivers and sub gate drivers. More specifically, a main gate driver 200(m1) is arranged on the left side of the display region 400, a main gate driver 200(m2) is arranged on the right side of the display region 400, a sub gate driver 200(s1) is arranged on the left side of the right projecting portion 410R, and a sub gate driver 200(s2) is arranged on the right side of the left projecting portion 410L.

Note that, in the present embodiment, a first-type scanning signal line drive circuit is implemented by a main gate driver and a second-type scanning signal line drive circuit is implemented by a sub gate driver. Note also that one pair of scanning signal line driving units is implemented by the main gate driver 200(m1) and the sub gate driver 200(s1), and the other pair of scanning signal line driving units is implemented by the main gate driver 200(m2) and the sub gate driver 200(s2). That is, in the present embodiment, two pairs of scanning signal line driving units are provided.

The main gate driver 200(m1) drives the gate bus lines GL(1L), GL(3L), . . . , GL(2n−1L), GL(2n+1), GL(2n+3), . . . , GL(2m−1). The main gate driver 200(m2) drives the gate bus lines GL(2R), GL(4R), . . . , GL(2nR), GL(2n+2), GL(2n+4), . . . , GL(2m). The sub gate driver 200(s1) drives the gate bus lines GL(1R), GL(3R), . . . , GL(2n−1R). The sub gate driver 200(s2) drives the gate bus lines GL(2L), GL(4L), . . . , GL(2nL).

As described above, each of odd-numbered gate bus lines GL in the projecting portions and the rectangular portion is driven by a gate driver 200 arranged on the left side of the relevant gate bus line GL, and each of even-numbered gate bus lines GL in the projecting portions and the rectangular portion is driven by gate drivers 200 arranged on the right side of the relevant gate bus line GL. Specifically, in the left projecting portion 410L, the gate bus lines GL(1L) to GL(2nL) are alternately driven one by one by the main gate driver 200(m1) and the sub gate driver 200(s2). In addition, in the right projecting portion 410R, the gate bus lines GL(1R) to GL(2nR) are alternately driven one by one by the sub gate driver 200(s1) and the main gate driver 200(m2). Furthermore, in the rectangular portion, the gate bus lines GL(2n+1) to GL(2m) are alternately driven one by one by the main gate driver 200(m1) and the main gate driver 200(m2). Such alternate one-by-one driving of the gate bus lines GL by the gate drivers 200 arranged on the left side and the gate drivers 200 arranged on the right side is hereinafter referred to as “staggered driving”.

Now, attention is focused on, for example, the main gate driver 200(m1). Regarding the gate bus lines driven by the main gate driver 200(m1), as is clear from FIG. 1, the length of the gate bus lines GL(1L), GL(3L), . . . , GL(2n−1L) is half or less of the length of the gate bus lines GL(2n+1), GL(2n+3), . . . , GL(2m−1). Therefore, a wiring line load by the gate bus lines GL(1L), GL(3L), . . . , GL(2n−1L) is also half or less of a wiring line load by the gate bus lines GL(2n+1), GL(2n+3), . . . , GL(2m−1). Hence, regarding both or one of the thin film transistor T1 and the thin film transistor T2 in the unit circuit (see FIGS. 4 and 5) SR included in the shift register circuit 210, it is preferred that the thin film transistor T1 and/or the thin film transistor T2 in unit circuits SR connected to the gate bus lines GL(1L), GL(3L), . . . , GL(2n−1L) be smaller in size than the thin film transistor T1 and/or the thin film transistor T2 in unit circuits SR connected to the gate bus lines GL(2n+1), GL(2n+3), . . . , GL(2m−1). By thus varying the size of the thin film transistor (the size of both or one of the thin film transistor T1 and the thin film transistor T2 in the unit circuit SR connected to the gate bus line GL) depending on the wiring line load of the gate bus line GL in each gate driver 200, consistency between a wiring line load and a driving capability can be achieved. As a result, an effect of power consumption optimization and an effect of a reduction in non-uniformity of display which occurs due to a difference in scanning signal waveform caused by a difference in wiring line load can be obtained. The same also applies to all embodiments and all variants which will be described later.

Meanwhile, in the above description, the shift register circuit 210 in each gate driver 200 includes k unit circuits SR1 to SRk (k is a natural number). Regarding this, in the present embodiment, “k=m” for the main gate drivers 200(m1) and 200(m2) and “k=n” for the sub gate drivers 200 (s1) and 200(s2).

<1.2.3 Relationship Between a Gate Driver Region and a Conventional Bypass Wiring Line Region>

Now, with reference to FIG. 8, a relationship between a region where a sub gate driver is provided (hereinafter, simply referred to as “gate driver region”) and a conventional bypass wiring line region will be described. FIG. 8 shows a portion of the recessed portion 500 near its lower edge. Note that here the circuit width of the gate driver region (the circuit width in a direction in which the gate bus lines GL extend) is WD. It is assumed that, in the configuration shown in FIG. 1, the gate bus lines disposed in the left projecting portion 410L and the gate bus lines disposed in the right projecting portion 410R are connected to each other by bypass wiring lines GLr as in conventional displays. At this time, when the width of one bypass wiring line GLr is Wg, the wiring line pitch of the bypass wiring lines GLr (the sum of the width of a bypass wiring line GLr and the distance between two adjacent bypass wiring lines GLr) is Wg×2, and the number of the bypass wiring lines GLr is Nr (in the configuration shown in FIG. 1, “Nr=2n”), the width Wr of a required bypass wiring line region is Wg×2×Nr. Considering the above-described respect, the configuration according to the present embodiment is preferably adopted when “WD<Wr” holds true.

<1.2.4 Driving Method>

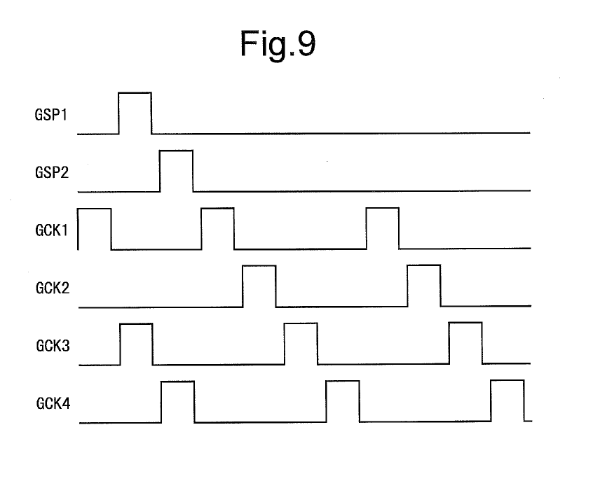

With reference to FIGS. 1, 9, and 10, a driving method of the present embodiment will be described. In the present embodiment, as gate control signals (timing control signals) GCTL, two gate start pulse signals GSP1 and GSP2 and four gate clock signals GCK1 to GCK4 such as those shown in FIG. 9 are used. The gate clock signal GCK1 and the gate clock signal GCK3 are shifted in phase by 180 degrees, the gate clock signal GCK2 and the gate clock signal GCK4 are shifted in phase by 180 degrees, and the phase of the gate clock signal GCK1 is 90 degrees ahead of the phase of the gate clock signal GCK2.

Under the above-described presumption, as shown in FIG. 1, the gate start pulse signal GSP1, the gate clock signal GCK1, and the gate clock signal GCK3 are provided to the main gate driver 200(m1) and the sub gate driver 200(s1), and the gate start pulse signal GSP2, the gate clock signal GCK2, and the gate clock signal GCK4 are provided to the main gate driver 200 (m2) and the sub gate driver 200(s2). To the shift register circuit (see FIG. 4) 210 included in each of the main gate driver 200(m1) and the sub gate driver 200(s1) are provided the gate start pulse signal GSP1 as the above-described gate start pulse signal ST, the gate clock signal GCK1 as the above-described first gate clock signal CK1, and the gate clock signal GCK3 as the above-described second gate clock signal CK2. To the shift register circuit (see FIG. 4) 210 included in each of the main gate driver 200(m2) and the sub gate driver 200(s2) are provided the gate start pulse signal GSP2 as the above-described gate start pulse signal ST, the gate clock signal GCK2 as the above-described first gate clock signal CK1, and the gate clock signal GCK4 as the above-described second gate clock signal CK2.

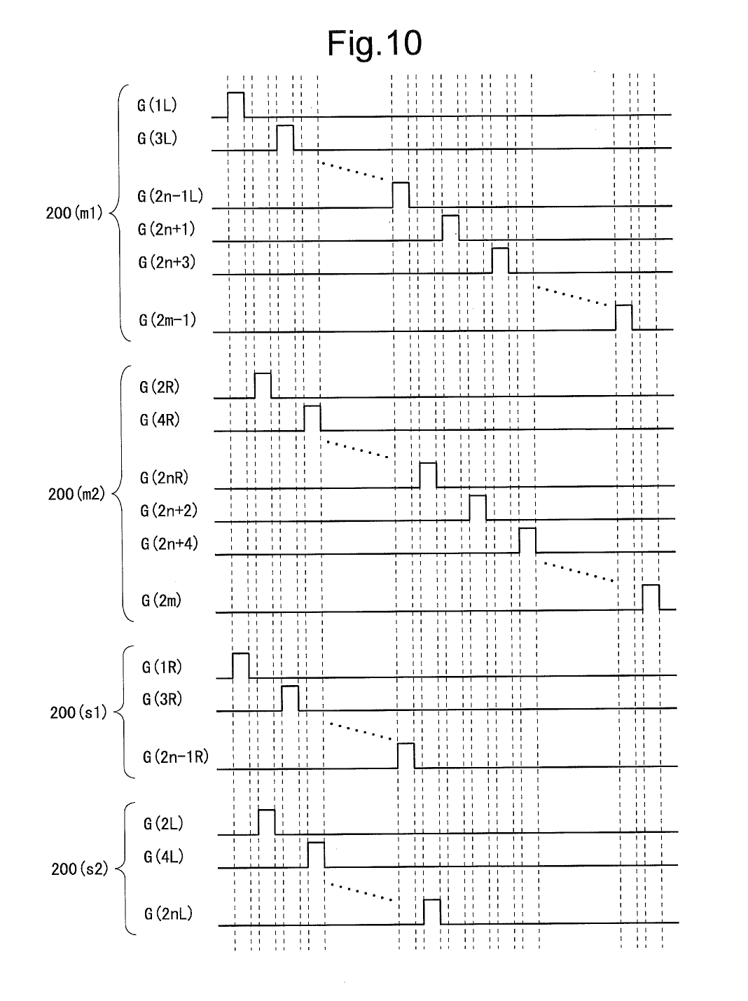

By providing the gate start pulse signals and the gate clock signals to the shift register circuits 210 in the gate drivers 200 in the above-described manner, scanning signals are outputted from each gate driver 200 as shown in FIG. 10. Note that in FIG. 10 a scanning signal provided to a gate bus line GL( . . . ) (see FIG. 1) is given reference character G( . . . ). For example, a scanning signal provided to the gate bus line GL(2n+3) is given reference character G(2n+3).

From FIG. 10, the following can be grasped. In the left projecting portion 410L, by alternately outputting active scanning signals from the main gate driver 200(m1) and the sub gate driver 200(s2), the gate bus lines GL(1L) to GL(2nL) are sequentially placed in a selected state. In addition, in the right projecting portion 410R, by alternately outputting active scanning signals from the sub gate driver 200(s1) and the main gate driver 200(m2), the gate bus lines GL(1R) to GL(2nR) are sequentially placed in a selected state. Here, a scanning signal G(zL) and a scanning signal G(zR) become active at the same timing (z is an integer between 1 and 2n, inclusive). That is, the scanning start timing of the gate bus lines GL disposed in the left projecting portion 410L is the same as the scanning start timing of the gate bus lines GL disposed in the right projecting portion 410R, and the scanning end timing of the gate bus lines GL disposed in the left projecting portion 410L is the same as the scanning end timing of the gate bus lines GL disposed in the right projecting portion 410R. After the end of scanning of the gate bus lines GL disposed in the left projecting portion 410L, the operation of the sub gate driver 200(s2) stops, and after the end of scanning of the gate bus lines GL disposed in the right projecting portion 410R, the operation of the sub gate driver 200(s1) stops. Thereafter, in the rectangular portion, by alternately outputting active scanning signals from the main gate driver 200(m1) and the main gate driver 200(m2), the gate bus lines GL(2n+1) to GL(2m) are sequentially placed in a selected state.

As described above, when attention is focused on a main gate driver and a sub gate driver in a pair, the sub gate driver drives gate bus lines that correspond to some of the gate bus lines driven by the main gate driver and that are not connected to the gate bus lines driven by the main gate driver. In addition, the main gate driver and the sub gate driver drive the corresponding gate bus lines at the same timing, based on the same gate control signals (timing control signals) GCTL.

<1.3 Regarding Wiring Lines for the Gate Control Signals>

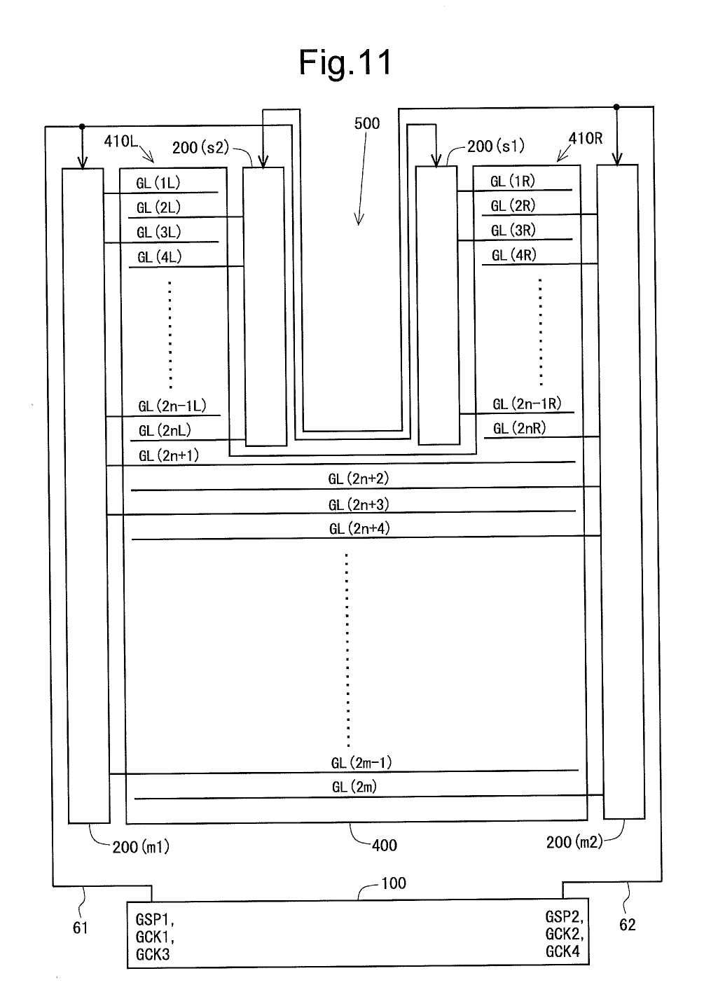

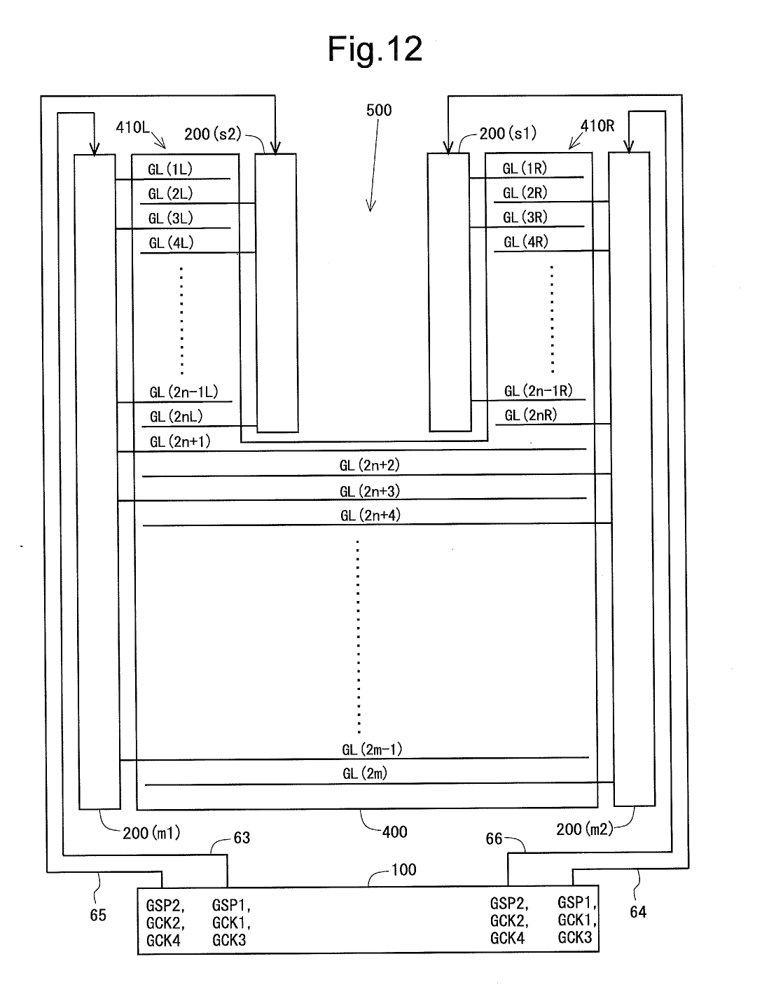

Now, wiring lines for the gate control signals GCTL to be provided to the gate drivers 200 from the display control circuit 100 will be described. For the wiring lines for the gate control signals GCTL, for example, a configuration shown in FIG. 11 (hereinafter, referred to as “first configuration”) or a configuration shown in FIG. 12 (hereinafter, referred to as “second configuration”) can be adopted.

In the first configuration, the gate start pulse signal GSP1 and the gate clock signals GCK1 and GCK3 are supplied using the same signal wiring line 61 to the main gate driver 200(m1) and the sub gate driver 200(s1), and the gate start pulse signal GSP2 and the gate clock signals GCK2 and GCK4 are supplied using the same signal wiring line 62 to the main gate driver 200(m2) and the sub gate driver 200(s2). As such, the gate control signals (timing control signals) GCTL are supplied using the same signal wiring line to a main gate driver and a sub gate driver in a pair.

According to the first configuration, a signal wiring line for the gate control signals GCTL is shared by the main gate driver 200(m1) and the sub gate driver 200(s1), and a signal wiring line for the gate control signals GCTL is shared by the main gate driver 200(m2) and the sub gate driver 200(s2). Hence, in a region around the display region 400, the circuit area for the gate drivers can be reduced. By this, a narrow picture-frame in the region around the display region 400 can be achieved.

In the second configuration, the gate start pulse signal GSP1 and the gate clock signals GCK1 and GCK3 are supplied to the main gate driver 200(m1) using a signal wiring line 63, and the gate start pulse signal GSP1 and the gate clock signals GCK1 and GCK3 are supplied to the sub gate driver 200(s1) using a signal wiring line 64. That is, the same three signals are supplied to the main gate driver 200(m1) and the sub gate driver 200(s1) using different signal wiring lines. In addition, in the second configuration, the gate start pulse signal GSP2 and the gate clock signals GCK2 and GCK4 are supplied to the main gate driver 200(m2) using a signal wiring line 66, and the gate start pulse signal GSP2 and the gate clock signals GCK2 and GCK4 are supplied to the sub gate driver 200(s2) using a signal wiring line 65. That is, the same three signals are supplied to the main gate driver 200(m2) and the sub gate driver 200(s1) using different signal wiring lines. As such, the gate control signals (timing control signals) GCTL are supplied to a main gate driver and a sub gate driver in a pair, using different signal wiring lines that do not pass through a non-display region (recessed portion 500) between the left projecting portion 410L and the right projecting portion 410R.

According to the second configuration, wiring lines for the gate control signals GCTL are not provided in the recessed portion 500. Hence, a narrow picture-frame is effectively achieved in the conventional bypass wiring line region.

<1.4 Effect>

According to the present embodiment, in a liquid crystal display device having the right-angled U-shaped display region 400 and adopting staggered driving as a driving method, the sub gate driver 200(s2) for driving some of gate bus lines GL disposed in the left projecting portion 410L is provided, in a region in the recessed portion 500, in a vicinity of the left projecting portion 410L, and the sub gate driver 200(s1) for driving some of gate bus lines GL disposed in the right projecting portion 410R is provided, in a region in the recessed portion 500, in a vicinity of the right projecting portion 410R. By thus providing the sub gate drivers in a region where bypass wiring lines for connecting the gate bus lines GL disposed in the left projecting portion 410L to the gate bus lines GL disposed in the right projecting portion 410R are conventionally disposed, even if there are a large number of gate bus lines GL disposed in the left projecting portion 410L and the right projecting portion 410R, the area of a picture-frame region required for the recessed portion 500 can be reduced over conventional displays. As such, according to the present embodiment, a variant-form display (a display device having a right-angled U-shaped display region) achieves a narrower picture-frame than conventional displays.

<1.5 Variants>

Variants of the above-described first embodiment will be described below.

<1.5.1 First Variant>

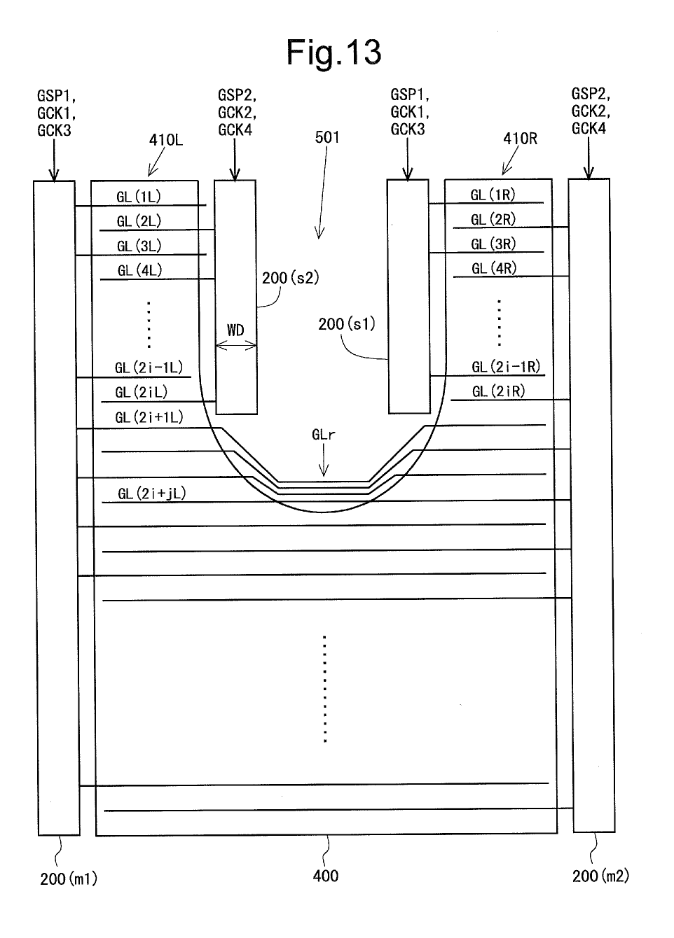

FIG. 13 is a diagram for describing a configuration of a first variant of the first embodiment. As can be grasped from FIG. 13, in the present variant, unlike the first embodiment, a U-shaped recessed portion 501 is provided. Note that here a portion of a display region 400 on the lower side than a lower edge of the recessed portion 501 is referred to as “rectangular portion”.

As in the first embodiment, a main gate driver 200 (m1) is arranged on the left side of the display region 400, a main gate driver 200(m2) is arranged on the right side of the display region 400, a sub gate driver 200(s1) is arranged on the left side of a right projecting portion 410R, and a sub gate driver 200(s2) is arranged on the right side of a left projecting portion 410L. How to provide gate control signals GCTL to each gate driver 200 is also the same as in the first embodiment.

In the present variant, some gate bus lines disposed in the left projecting portion 410L and some gate bus lines disposed in the right projecting portion 410R are connected to each other by bypass wiring lines GLr. In the present variant, in a region where the area of a picture-frame is reduced by the provision of the bypass wiring lines GLr, the bypass wiring lines GLr are thus provided. Gate bus lines GL(1L) to GL(2iL) that are not connected to the bypass wiring lines GLr among gate bus lines disposed in the left projecting portion 410L are alternately driven one by one by the main gate driver 200(m1) and the sub gate driver 200(s2). In addition, gate bus lines GL(1R) to GL(2iR) that are not connected to the bypass wiring lines GLr among gate bus lines disposed in the right projecting portion 410R are alternately driven one by one by the sub gate driver 200(s1) and the main gate driver 200(m2). Furthermore, gate bus lines GL(2i+1L) to GL(2i+jL) that are connected to the bypass wiring lines GLr among gate bus lines disposed in the left projecting portion 410L and the right projecting portion 410R are alternately driven one by one by the main gate driver 200 (m1) and the main gate driver 200(m2). As such, the gate bus lines connected to the bypass wiring lines GLr are driven by the main gate drivers

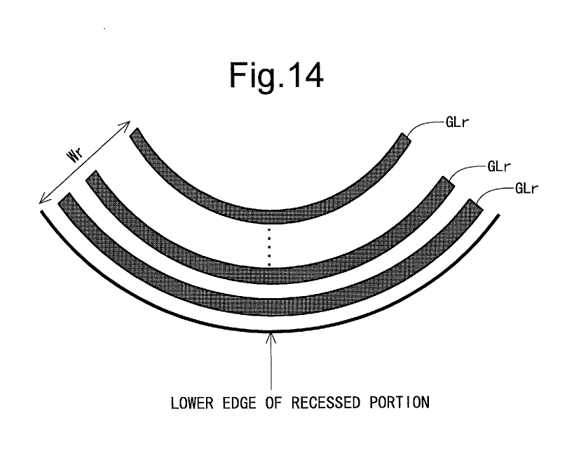

Now, with reference to FIG. 14, how to determine the number of gate bus lines GL driven using the bypass wiring lines GLr will be described. FIG. 14 shows a portion of the recessed portion 501 near its lower edge. When the width of the bypass wiring lines GLr is Wg, the wiring line pitch of the bypass wiring lines GLr (the sum of the width of a bypass wiring line GLr and the distance between two adjacent bypass wiring lines GLr) is Wg×2, and the number of the bypass wiring lines GLr is Nr, the width Wr of a required bypass wiring line region is Wg×2×Nr. At this time, when the circuit width of the gate drivers 200 (the sub gate drivers 200(s1) and 200(s2)) provided in the recessed portion 501 (the circuit width in a direction in which the gate bus lines GL extend) is WD, the number Nr of the bypass wiring lines GLr is determined so as to satisfy “Wr<WD”. When the number Nr of the bypass wiring lines GLr is determined in this manner, the size of a picture-frame in a region where the bypass wiring lines GLr are disposed can be reduced over a case in which the bypass wiring lines GLr are not provided. As such, according to the present variant, by adopting a configuration in which the sub gate drivers and the bypass wiring lines GLr are combined, as a configuration for driving the gate bus lines GL, a narrow picture-frame can be more effectively achieved over conventional displays.

<1.5.2 Second Variant>

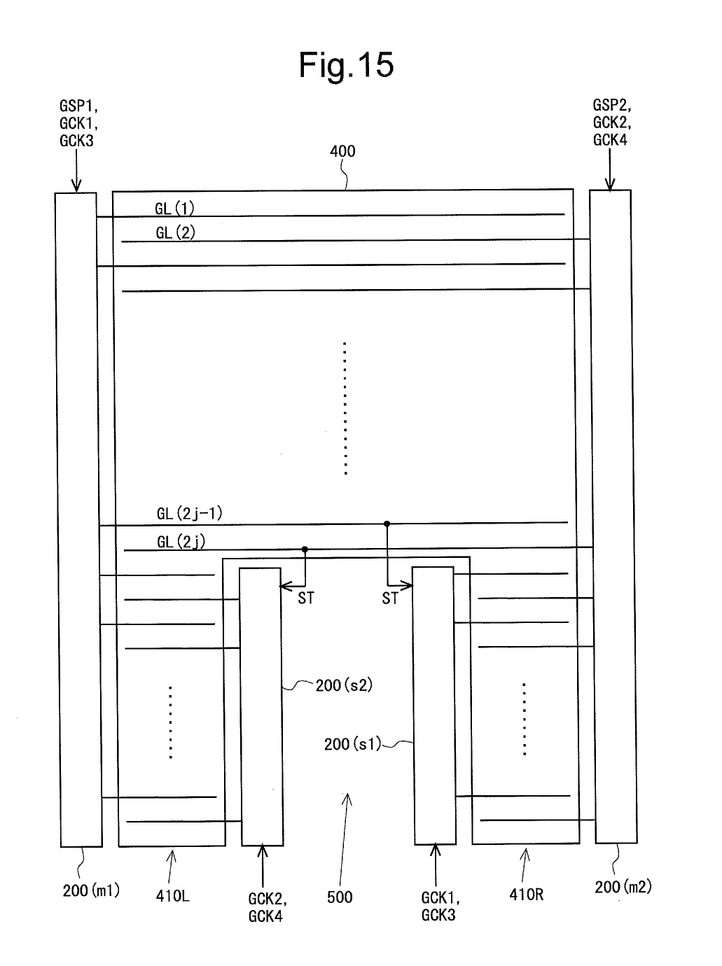

FIG. 15 is a diagram for describing a configuration of a second variant of the first embodiment. As shown in FIG. 15, a display region 400 of the present variant has a right-angled U-shape having a recessed portion 500 on the lower side as viewed from the top. Therefore, unlike the first embodiment, nearly the upper-half region of the display region 400 serves as a rectangular portion. In addition, here, a projecting portion of the display region 400 present on the lower left side in FIG. 15 is referred to as “left projecting portion”, and a projecting portion of the display region 400 present on the lower right side in FIG. 15 is referred to as “right projecting portion”. As in the first embodiment, the left projecting portion is given reference character 410L and the right projecting portion is given reference character 410R.

In the present variant, too, a main gate driver 200(m1) is arranged on the left side of the display region 400, a main gate driver 200(m2) is arranged on the right side of the display region 400, a sub gate driver 200(s1) is arranged on the left side of the right projecting portion 410R, and a sub gate driver 200(s2) is arranged on the right side of the left projecting portion 410L.

A gate start pulse signal GSP1, a gate clock signal GCK1, and a gate clock signal GCK3 are provided to the main gate driver 200(m1). A gate start pulse signal GSP2, a gate clock signal GCK2, and a gate clock signal GCK4 are provided to the main gate driver 200(m2). The gate clock signal GCK1 and the gate clock signal GCK3 are provided to the sub gate driver 200(s1). The gate clock signal GCK2 and the gate clock signal GCK4 are provided to the sub gate driver 200(s2).

Here, 2j gate bus lines GL(1) to GL(2j) (j is a natural number) are disposed in the rectangular portion. A scanning signal provided to the gate bus line GL(2j−1) is provided as a gate start pulse signal ST (see FIG. 4) to the sub gate driver 200(s1). In addition, a scanning signal provided to the gate bus line GL(2j) is provided as a gate start pulse signal ST to the sub gate driver 200(s1). As such, in the present variant, a scanning signal which is outputted by a main gate driver to a gate bus line disposed in the rectangular portion is provided as a gate start pulse signal (scanning start signal) ST to a sub gate driver. Hence, wiring lines for gate start pulse signals to be provided to the sub gate drivers are not required.

By the above-described configuration, in the rectangular portion, the 2j gate bus lines are alternately driven one by one by the main gate driver 200(m1) and the main gate driver 200(m2). In addition, in the left projecting portion 410L, a plurality of gate bus lines are alternately driven one by one by the main gate driver 200(m1) and the sub gate driver 200(s2). Furthermore, in the right projecting portion 410R, a plurality of gate bus lines are alternately driven one by one by the sub gate driver 200(s1) and the main gate driver 200(m2).

<1.5.3 Third Variant>

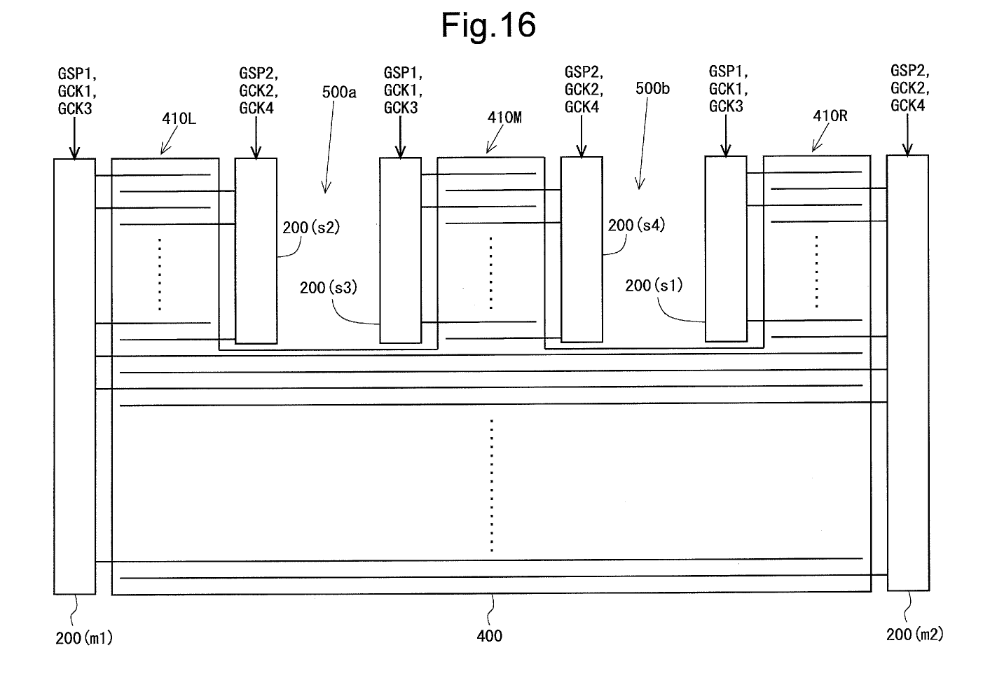

FIG. 16 is a diagram for describing a configuration of a third variant of the first embodiment. As shown in FIG. 16, a display region 400 of the present variant has a roughly rectangular shape provided with recessed portions 500a and 500b at two locations on the upper side as viewed from the top. As in the first embodiment, nearly the lower-half region of the display region 400 serves as a rectangular portion. Note that here a projecting portion of the display region 400 present on the upper left side in FIG. 16 is referred to as “left projecting portion”, a projecting portion of the display region 400 present on the upper side of a middle portion in FIG. 16 is referred to as “middle projecting portion”, and a projecting portion of the display region 400 present on the upper right side in FIG. 16 is referred to as “right projecting portion”. The left projecting portion is given reference character 410L, the middle projecting portion is given reference character 410M, and the right projecting portion is given reference character 410R.

In the present variant, as shown in FIG. 16, gate drivers are arranged at six locations. More specifically, a main gate driver 200(m1) is arranged on the left side of the display region 400, a main gate driver 200(m2) is arranged on the right side of the display region 400, a sub gate driver 200(s1) is arranged on the left side of the right projecting portion 410R, a sub gate driver 200(s2) is arranged on the right side of the left projecting portion 410L, a sub gate driver 200(s3) is arranged on the left side of the middle projecting portion 410M, and a sub gate driver 200(s4) is arranged on the right side of the middle projecting portion 410M. Note that one pair of scanning signal line driving units is implemented by the main gate driver 200(m1) and the sub gate driver 200(s1), and the other pair of scanning signal line driving units are implemented by the main gate driver 200(m2) and the sub gate driver 200(s2).

A gate start pulse signal GSP1, a gate clock signal GCK1, and a gate clock signal GCK3 are provided to the main gate driver 200(m1), the sub gate driver 200(s1), and the sub gate driver 200(s3), and a gate start pulse signal GSP2, a gate clock signal GCK2, and a gate clock signal GCK4 are provided to the main gate driver 200(m2), the sub gate driver 200(s2), and the sub gate driver 200(s4).

The number of gate bus lines GL disposed in the left projecting portion 410L, the number of gate bus lines GL disposed in the middle projecting portion 410M, and the number of gate bus lines GL disposed in the right projecting portion 410R are equal.

By the above-described configuration, in the left projecting portion 410L, a plurality of gate bus lines are alternately driven one by one by the main gate driver 200(m1) and the sub gate driver 200(s2). In addition, in the middle projecting portion 410M, a plurality of gate bus lines are alternately driven one by one by the sub gate driver 200(s3) and the sub gate driver 200(s4). In the right projecting portion 410R, a plurality of gate bus lines are alternately driven one by one by the sub gate driver 200(s1) and the main gate driver 200(m2). In the rectangular portion, a plurality of gate bus lines are alternately driven one by one by the main gate driver 200(m1) and the main gate driver 200(m2).

<1.5.4 Fourth Variant>

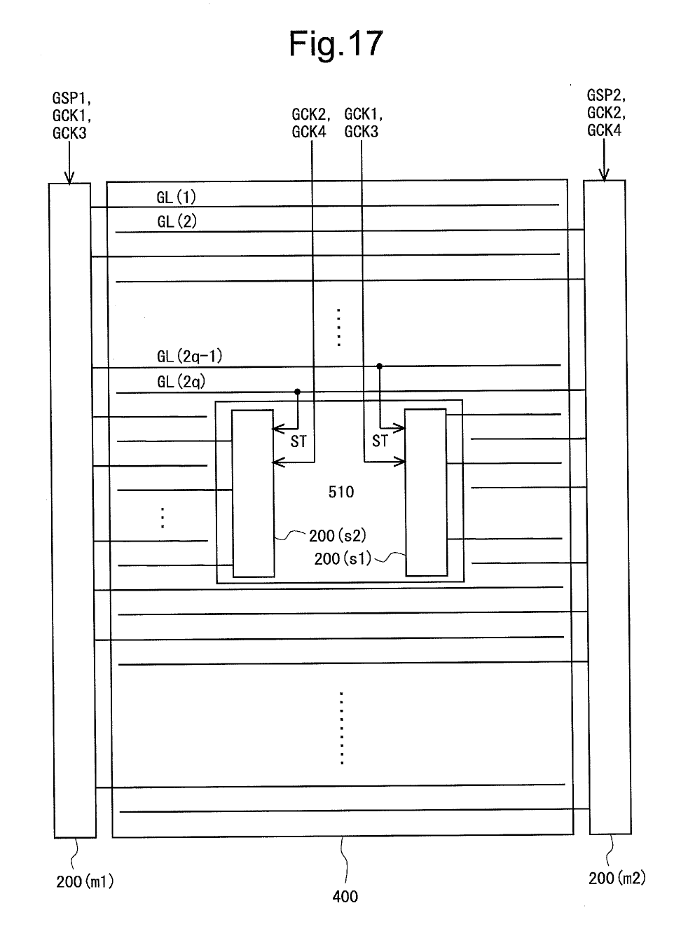

FIG. 17 is a diagram for describing a configuration of a fourth variant of the first embodiment. As shown in FIG. 17, a display region 400 of the present variant has a roughly rectangular shape provided with a hole portion 510 in a middle portion as viewed from the top. Note that, here, a portion of the display region 400 on the left side of the hole portion 510 is referred to as “left rectangular portion”, and a portion of the display region 400 on the right side of the hole portion 510 is referred to as “right rectangular portion”. In addition, a portion of the display region 400 on the upper side of the left rectangular portion, the hole portion 510, and the right rectangular portion is referred to as “upper rectangular portion”, and a portion of the display region 400 on the lower side of the left rectangular portion, the hole portion 510, and the right rectangular portion is referred to as “lower rectangular portion”. In the present variant, a wide-width region is implemented by the upper rectangular portion and the lower rectangular portion, and two narrow-width regions are implemented by the left rectangular portion and the right rectangular portion.

In the present variant, a main gate driver 200(m1) is arranged on the left side of the display region 400, a main gate driver 200(m2) is arranged on the right side of the display region 400, a sub gate driver 200(s1) is arranged on the left side of the right rectangular portion (i.e., a right-side region of the hole portion 510), and a sub gate driver 200(s2) is arranged on the right side of the left rectangular portion (i.e., a left-side region of the hole portion 510).

A gate start pulse signal GSP1, a gate clock signal GCK1, and a gate clock signal GCK3 are provided to the main gate driver 200(m1). A gate start pulse signal GSP2, a gate clock signal GCK2, and a gate clock signal GCK4 are provided to the main gate driver 200(m2). The gate clock signal GCK1 and the gate clock signal GCK3 are provided to the sub gate driver 200(s1). The gate clock signal GCK2 and the gate clock signal GCK4 are provided to the sub gate driver 200(s2).

Here, 2q gate bus lines GL(1) to GL(2q) (q is a natural number) are disposed in the upper rectangular portion. A scanning signal provided to the gate bus line GL(2q−1) is provided as a gate start pulse signal ST (see FIG. 4) to the sub gate driver 200(s1). In addition, a scanning signal provided to the gate bus line GL(2q) is provided as a gate start pulse signal ST to the sub gate driver 200(s2). As such, a scanning signal which is outputted by a main gate driver to a gate bus line disposed in the upper rectangular portion is provided as a gate start pulse signal (scanning start signal) ST to a sub gate driver. Note that the number of gate bus lines GL disposed in the left rectangular portion and the number of gate bus lines GL disposed in the right rectangular portion are equal.

By the above-described configuration, in the upper rectangular portion, the 2q gate bus lines are alternately driven one by one by the main gate driver 200(m1) and the main gate driver 200(m2). In addition, in the left rectangular portion, a plurality of gate bus lines are alternately driven one by one by the main gate driver 200(m1) and the sub gate driver 200(s2). Furthermore, in the right rectangular portion, a plurality of gate bus lines are alternately driven one by one by the sub gate driver 200(s1) and the main gate driver 200(m2). Moreover, in the lower rectangular portion, a plurality of gate bus lines are alternately driven one by one by the main gate driver 200(m1) and the main gate driver 200(m2).

<1.5.5 Fifth Variant>

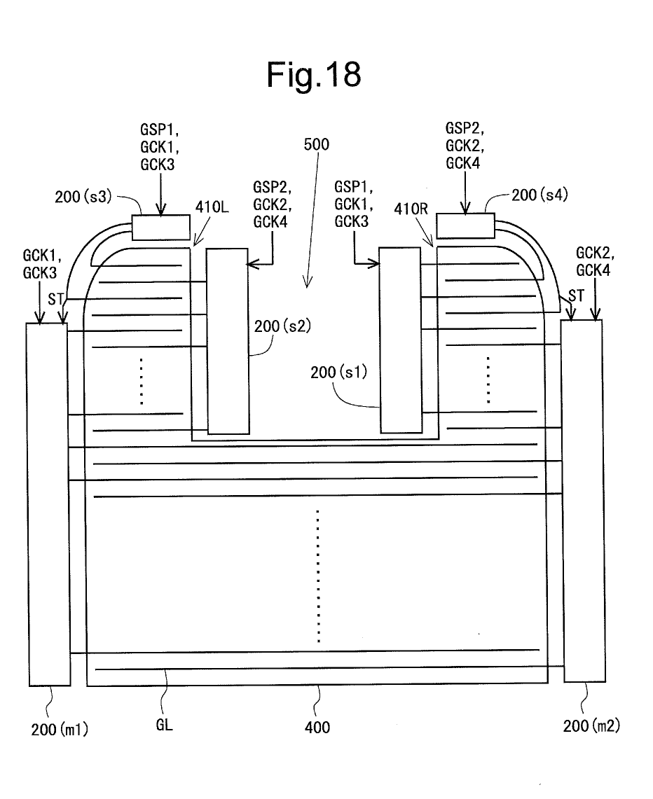

FIG. 18 is a diagram for describing a configuration of a fifth variant of the first embodiment. As shown in FIG. 18, a display region 400 of the present variant has a roughly right-angled U-shape having a recessed portion 500 on the upper side as viewed from the top, as in the first embodiment. Note, however, that the upper left and upper right portions of the display region 400 have an arc shape.

In the present variant, as shown in FIG. 18, gate drivers are arranged at six locations. More specifically, a main gate driver 200(m1) is arranged on the left side of the display region 400, a main gate driver 200(m2) is arranged on the right side of the display region 400, a sub gate driver 200(s1) is arranged on the left side of a right projecting portion 410R, a sub gate driver 200(s2) is arranged on the right side of a left projecting portion 410L, a sub gate driver 200(s3) is arranged on the upper side of the left projecting portion 410L, and a sub gate driver 200(s4) is arranged on the upper side of the right projecting portion 410R.

A gate start pulse signal GSP1, a gate clock signal GCK1, and a gate clock signal GCK3 are provided to the sub gate driver 200 (s1) and the sub gate driver 200(s3). The gate clock signal GCK1 and the gate clock signal GCK3 are provided to the main gate driver 200(m1), in addition to a signal that synchronizes with a scanning signal to be provided to a gate bus line GL, as a gate start pulse signal ST (see FIG. 18). A gate start pulse signal GSP2, a gate clock signal GCK2, and a gate clock signal GCK4 are provided to the sub gate driver 200(s2) and the sub gate driver 200(s4). The gate clock signal GCK2 and the gate clock signal GCK4 are provided to the main gate driver 200(m2), in addition to a signal that synchronizes with a scanning signal to be provided to a gate bus line GL, as a gate start pulse signal ST (see FIG. 18).

Now, attention is focused on the left projecting portion 410L. In an upper-side region of the left projecting portion 410L, gate bus lines connected to the sub gate driver 200(s3) and gate bus lines connected to the sub gate driver 200(s2) are disposed. In addition, in a lower-side region of the left projecting portion 410L, gate bus lines connected to the main gate driver 200(m1) and gate bus lines connected to the sub gate driver 200(s2) are disposed. Next, attention is focused on the right projecting portion 410R. In an upper-side region of the right projecting portion 410R, gate bus lines connected to the sub gate driver 200(s1) and gate bus lines connected to the sub gate driver 200(s4) are disposed. In addition, in a lower-side region of the right projecting portion 410R, gate bus lines connected to the sub gate driver 200(s1) and gate bus lines connected to the main gate driver 200(m2) are disposed.

By the above-described configuration, in the upper-side region of the left projecting portion 410L, a plurality of gate bus lines are alternately driven one by one by the sub gate driver 200(s3) and the sub gate driver 200(s2). In the lower-side region of the left projecting portion 410L, a plurality of gate bus lines are alternately driven one by one by the main gate driver 200(m1) and the sub gate driver 200(s2). In the upper-side region of the right projecting portion 410R, a plurality of gate bus lines are alternately driven one by one by the sub gate driver 200(s1) and the sub gate driver 200(s4). In the lower-side region of the right projecting portion 410R, a plurality of gate bus lines are alternately driven one by one by the sub gate driver 200(s1) and the main gate driver 200(m2). In the rectangular portion, a plurality of gate bus lines are alternately driven one by one by the main gate driver 200(m1) and the main gate driver 200(m2).

<1.5.6 Sixth Variant>

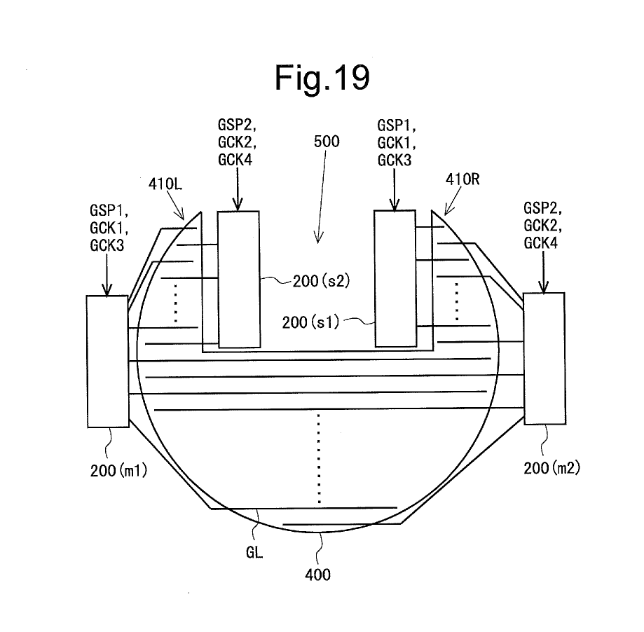

FIG. 19 is a diagram for describing a configuration of a sixth variant of the first embodiment. As shown in FIG. 19, a display region 400 of the present variant has a roughly circular shape provided with a recessed portion 500 on the upper side as viewed from the top. Note that nearly the lower-half region of the display region 400 is referred to as “semicircular portion”. In the present variant, a wide-width region is implemented by the semicircular portion.

In the present variant, a main gate driver 200(m1) is arranged on the left side of the display region 400, a main gate driver 200(m2) is arranged on the right side of the display region 400, a sub gate driver 200(s1) is arranged on the left side of a right projecting portion 410R, and a sub gate driver 200(s2) is arranged on the right side of a left projecting portion 410L.

A gate start pulse signal GSP1, a gate clock signal GCK1, and a gate clock signal GCK3 are provided to the main gate driver 200(m1) and the sub gate driver 200(s1), and a gate start pulse signal GSP2, a gate clock signal GCK2, and a gate clock signal GCK4 are provided to the main gate driver 200(m2) and the sub gate driver 200(s2).

By the above-described configuration, in the left projecting portion 410L, a plurality of gate bus lines are alternately driven one by one by the main gate driver 200(m1) and the sub gate driver 200(s2). In addition, in the right projecting portion 410R, a plurality of gate bus lines are alternately driven one by one by the sub gate driver 200(s1) and the main gate driver 200(m2). Furthermore, in the semicircular portion, a plurality of gate bus lines are alternately driven one by one by the main gate driver 200(m1) and the main gate driver 200(m2).

<1.5.7 Seventh Variant>

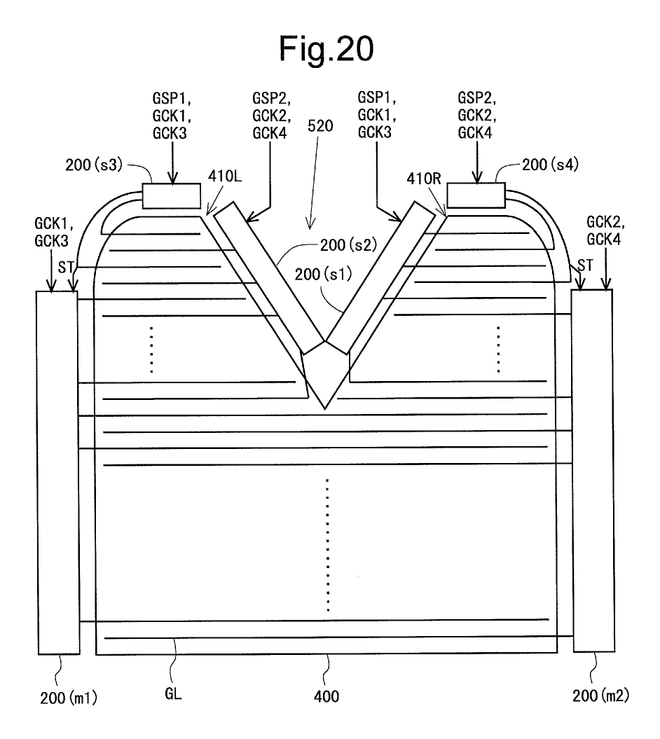

FIG. 20 is a diagram for describing a configuration of a seventh variant of the first embodiment. As shown in FIG. 20, a display region 400 of the present variant has a roughly rectangular shape provided with a V-shaped cut portion 520 on the upper side as viewed from the top. In addition, the upper left and upper right portions of the display region 400 have an arc shape. Note that, here, a projecting portion of the display region 400 present on the left side of the cut portion 520 is referred to as “left projecting portion”, and a projecting portion of the display region 400 present on the right side of the cut portion 520 is referred to as “right projecting portion”. As in the first embodiment, the left projecting portion is given reference character 410L and the right projecting portion is given reference character 410R. In addition, nearly the lower-half region of the display region 400 is referred to as “rectangular portion”.

In the present variant, as shown in FIG. 20, gate drivers are arranged at six locations. More specifically, a main gate driver 200(m1) is arranged on the left side of the display region 400, a main gate driver 200(m2) is arranged on the right side of the display region 400, a sub gate driver 200(s1) is arranged in a portion of the cut portion 520 near the right projecting portion 410R, a sub gate driver 200(s2) is arranged in a portion of the cut portion 520 near the left projecting portion 410L, a sub gate driver 200(s3) is arranged on the upper side of the left projecting portion 410L, and a sub gate driver 200(s4) is arranged on the upper side of the right projecting portion 410R.

A gate start pulse signal GSP1, a gate clock signal GCK1, and a gate clock signal GCK3 are provided to the sub gate driver 200 (s1) and the sub gate driver 200(s3). The gate clock signal GCK1 and the gate clock signal GCK3 are provided to the main gate driver 200(m1), in addition to a signal that synchronizes with a scanning signal to be provided to a gate bus line GL, as a gate start pulse signal ST (see FIG. 20). A gate start pulse signal GSP2, a gate clock signal GCK2, and a gate clock signal GCK4 are provided to the sub gate driver 200(s2) and the sub gate driver 200(s4). The gate clock signal GCK2 and the gate clock signal GCK4 are provided to the main gate driver 200(m2), in addition to a signal that synchronizes with a scanning signal to be provided to a gate bus line GL, as a gate start pulse signal ST (see FIG. 20).

As in the fifth variant, in an upper-side region of the left projecting portion 410L, gate bus lines connected to the sub gate driver 200(s3) and gate bus lines connected to the sub gate driver 200(s2) are disposed, and in a lower-side region of the left projecting portion 410L, gate bus lines connected to the main gate driver 200(m1) and gate bus lines connected to the sub gate driver 200(s2) are disposed. In addition, in an upper-side region of the right projecting portion 410R, gate bus lines connected to the sub gate driver 200(s1) and gate bus lines connected to the sub gate driver 200(s4) are disposed, and in a lower-side region of the right projecting portion 410R, gate bus lines connected to the sub gate driver 200(s1) and gate bus lines connected to the main gate driver 200(m2) are disposed.

By the above-described configuration, in the upper-side region of the left projecting portion 410L, a plurality of gate bus lines are alternately driven one by one by the sub gate driver 200(s3) and the sub gate driver 200(s2). In the lower-side region of the left projecting portion 410L, a plurality of gate bus lines are alternately driven one by one by the main gate driver 200(m1) and the sub gate driver 200(s2). In the upper-side region of the right projecting portion 410R, a plurality of gate bus lines are alternately driven one by one by the sub gate driver 200(s1) and the sub gate driver 200(s4). In the lower-side region of the right projecting portion 410R, a plurality of gate bus lines are alternately driven one by one by the sub gate driver 200(s1) and the main gate driver 200(m2). In the rectangular portion, a plurality of gate bus lines are alternately driven one by one by the main gate driver 200(m1) and the main gate driver 200(m2).

<1.5.8 Eighth Variant>

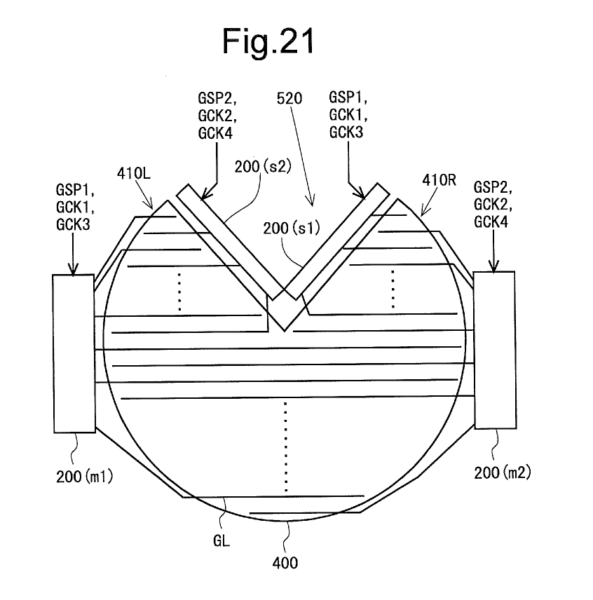

FIG. 21 is a diagram for describing a configuration of an eighth variant of the first embodiment. As shown in FIG. 21, a display region 400 of the present variant has a roughly circular shape provided with a V-shaped cut portion 520 on the upper side as viewed from the top. Note that, as in the seventh variant, a projecting portion of the display region 400 present on the left side of the cut portion 520 is referred to as “left projecting portion”, and a projecting portion of the display region 400 present on the right side of the cut portion 520 is referred to as “right projecting portion”. In addition, nearly the lower-half region of the display region 400 is referred to as “semicircular portion”.

In the present variant, a main gate driver 200(m1) is arranged on the left side of the display region 400, a main gate driver 200(m2) is arranged on the right side of the display region 400, a sub gate driver 200(s1) is arranged in a portion of the cut portion 520 near a right projecting portion 410R, and a sub gate driver 200(s1) is arranged in a portion of the cut portion 520 near a left projecting portion 410L.

A gate start pulse signal GSP1, a gate clock signal GCK1, and a gate clock signal GCK3 are provided to the main gate driver 200(m1) and the sub gate driver 200(s1), and a gate start pulse signal GSP2, a gate clock signal GCK2, and a gate clock signal GCK4 are provided to the main gate driver 200(m2) and the sub gate driver 200(s2).

By the above-described configuration, in the left projecting portion 410L, a plurality of gate bus lines are alternately driven one by one by the main gate driver 200(m1) and the sub gate driver 200(s2). In addition, in the right projecting portion 410R, a plurality of gate bus lines are alternately driven one by one by the sub gate driver 200(s1) and the main gate driver 200(m2). Furthermore, in the semicircular portion, a plurality of gate bus lines are alternately driven one by one by the main gate driver 200(m1) and the main gate driver 200(m2).

### 2. Second Embodiment

A second embodiment of the present invention will be described. Note that the following mainly describes differences from the above-described first embodiment and description of the same respects as those in the first embodiment is omitted.

In the first embodiment, staggered driving is adopted as a method for driving the gate bus lines GL. In contrast, in the present embodiment, “one-side driving” is adopted in which all of a plurality of gate bus lines GL arranged in each region are driven by a single gate driver 200. A detailed description will be made below.

<2.1 Configuration>

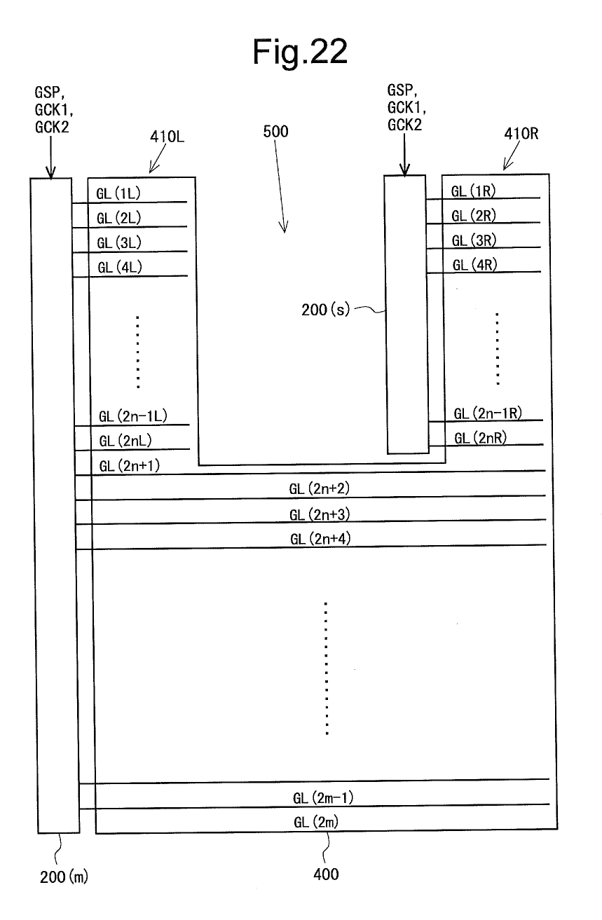

FIG. 22 is a diagram for describing the arrangement of gate drivers 200 of the present embodiment. As can be grasped from FIG. 22, as in the first embodiment, a display region 400 has a right-angled U-shape as viewed from the top. In the present embodiment, as shown in FIG. 22, gate drivers are arranged at two locations. More specifically, a main gate driver 200(m) is arranged on the left side of the display region 400, and a sub gate driver 200(s) is arranged on the left side of a right projecting portion 410R. As such, the gate drivers 200 include one main gate driver 200(m) and one sub gate driver 200(s). That is, in the present embodiment, a pair of scanning signal line driving units is provided.

The main gate driver 200(m) drives gate bus lines GL(1L) to GL(2nL) and GL(2n+1) to GL(2m). The sub gate driver 200(s) drives gate bus lines GL(1R) to GL(2nR). As such, each of gate bus lines disposed in a left projecting portion 410L and a rectangular portion is driven by the main gate driver 200(m) arranged on the left side of the relevant gate bus line, and each of gate bus lines disposed in the right projecting portion 410R is driven by the sub gate driver 200(s) arranged on the left side of the relevant gate bus line.

<2.2 Driving Method>

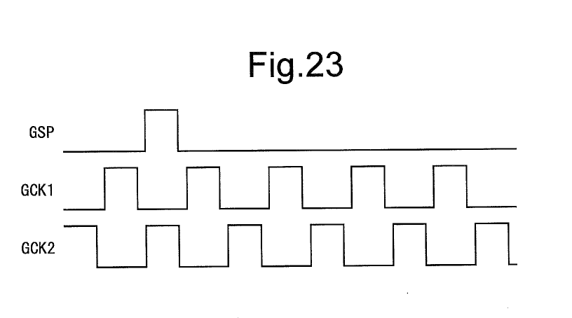

With reference to FIGS. 22 to 24, a driving method of the present embodiment will be described. In the present embodiment, as gate control signals GCTL, one gate start pulse signal GSP and two gate clock signals GCK1 and GCK2 such as those shown in FIG. 23 are used. The gate clock signal GCK1 and the gate clock signal GCK2 are shifted in phase by 180 degrees.

Under the above-described presumption, as shown in FIG. 22, the gate start pulse signal GSP, the gate clock signal GCK1, and the gate clock signal GCK2 are provided to the main gate driver 200(m) and the sub gate driver 200(s). To a shift register circuit (see FIG. 4) 210 included in each of the main gate driver 200(m) and the sub gate driver 200(s) are provided the gate start pulse signal GSP as the above-described gate start pulse signal ST, the gate clock signal GCK1 as the above-described first gate clock signal CK1, and the gate clock signal GCK2 as the above-described second gate clock signal CK2.

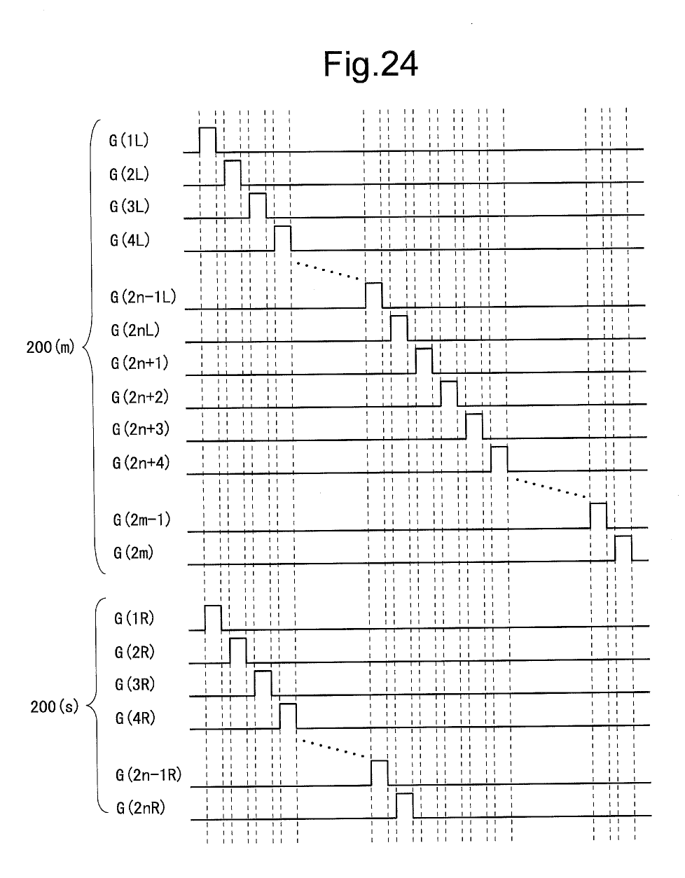

By providing the gate start pulse signal and the gate clock signals to the shift register circuits 210 in the gate drivers 200 in the above-described manner, scanning signals are outputted from each gate driver 200 as shown in FIG. 24. Note that, as in the first embodiment, in FIG. 24, a scanning signal provided to a gate bus line GL( . . . ) (see FIG. 22) is given reference character G( . . . ).

From FIG. 24, the following can be grasped. In the left projecting portion 410L, by sequentially outputting active scanning signals from the main gate driver 200(m), the gate bus lines GL(1L) to GL(2nL) are sequentially placed in a selected state. In addition, in the right projecting portion 410R, by sequentially outputting active scanning signals from the sub gate driver 200(s), the gate bus lines GL(1R) to GL(2nR) are sequentially placed in a selected state. Here, a scanning signal G(zL) and a scanning signal G(zR) become active at the same timing (z is an integer between 1 and 2n, inclusive). That is, the scanning start timing of the gate bus lines GL disposed in the left projecting portion 410L is the same as the scanning start timing of the gate bus lines GL disposed in the right projecting portion 410L, and the scanning end timing of the gate bus lines GL disposed in the left projecting portion 410L is the same as the scanning end timing of the gate bus lines GL disposed in the right projecting portion 410L. After the end of scanning of the gate bus lines GL disposed in the left projecting portion 410L and the gate bus lines GL disposed in the right projecting portion 410R, in the rectangular portion, active scanning signals are sequentially outputted from the main gate driver 200(m). By this, the gate bus lines GL(2n+1) to GL(2m) are sequentially placed in a selected state.

<2.3 Effect>

According to the present embodiment, in a liquid crystal display device having the right-angled U-shaped display region 400 and adopting one-side driving as a driving method, the sub gate driver 200(s) for driving the gate bus lines GL disposed in the right projecting portion 410R is provided, in a region in a recessed portion 500, in a vicinity of the right projecting portion 410R. By thus providing the sub gate driver in a region where bypass wiring lines for connecting the gate bus lines GL disposed in the left projecting portion 410L to the gate bus lines GL disposed in the right projecting portion 410R are conventionally disposed, even if there are a large number of gate bus lines GL disposed in the left projecting portion 410L and the right projecting portion 410R, the area of a picture-frame region required for the recessed portion 500 can be reduced over conventional displays. As such, as in the first embodiment, a variant-form display (a display device having a right-angled U-shaped display region) achieves a narrower picture-frame than conventional displays.

In addition, since one-side driving is adopted, the number of gate drivers 200 can be reduced compared with a configuration in which staggered driving is adopted or a configuration both-side driving which will be described later is adopted. Hence, a narrow picture-frame is more effectively achieved.

<2.4 Variants>

Variants of the above-described second embodiment will be described below.

<2.4.1 First Variant>

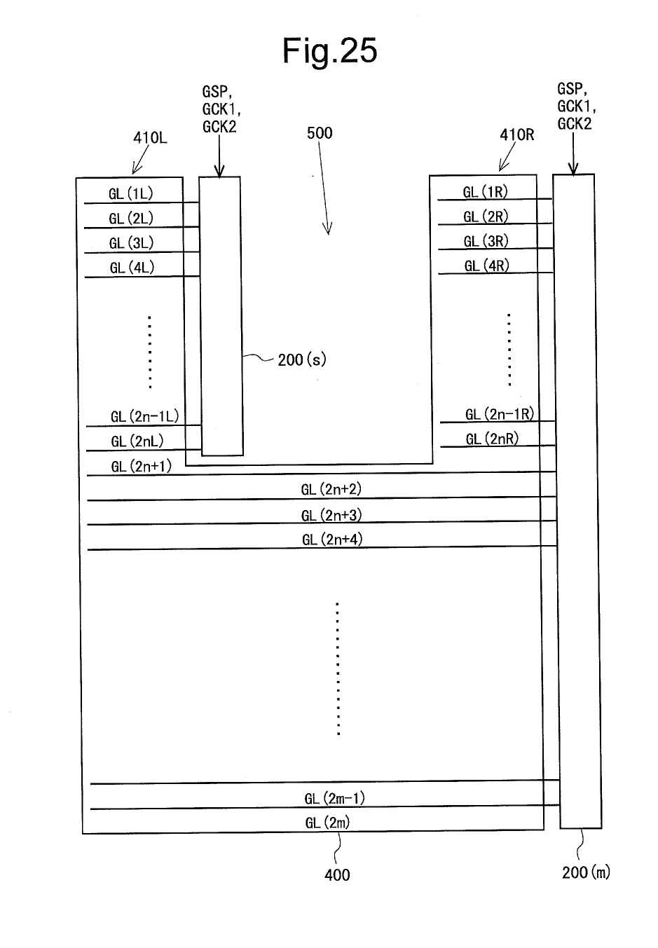

FIG. 25 is a diagram for describing a configuration of a first variant of the second embodiment. As in the second embodiment, a display region 400 has a right-angled U-shape as viewed from the top. In the present variant, unlike the second embodiment, a main gate driver 200(m) is arranged on the right side of the display region 400, and a sub gate driver 200(s) is arranged on the right side of a left projecting portion 410L. As in the second embodiment, a gate start pulse signal GSP, a gate clock signal GCK1, and a gate clock signal GCK2 are provided to the main gate driver 200(m) and the sub gate driver 200(s).

By the above-described configuration, in the left projecting portion 410L, a plurality of gate bus lines are sequentially driven one by one by the sub gate driver 200(s). In addition, in a right projecting portion 410R and a rectangular portion, a plurality of gate bus lines are sequentially driven one by one by the main gate driver 200(m).

<2.4.2 Second Variant>

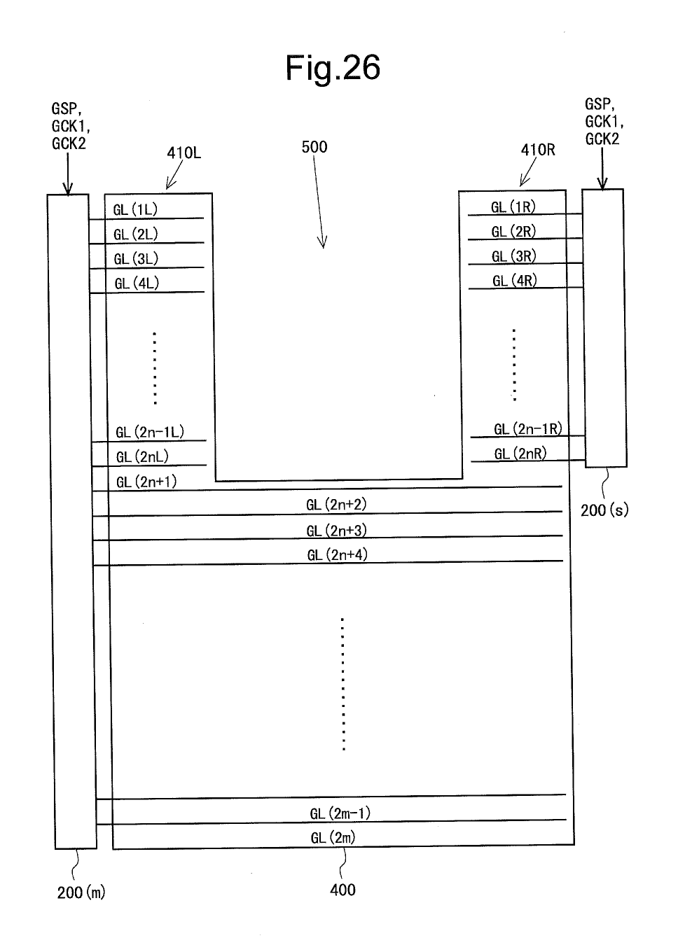

FIG. 26 is a diagram for describing a configuration of a second variant of the second embodiment. As in the second embodiment, a display region 400 has a right-angled U-shape as viewed from the top. In the present variant, unlike the second embodiment, a sub gate driver 200(s) is arranged on the right side of a right projecting portion 410R. As in the second embodiment, a gate start pulse signal GSP, a gate clock signal GCK1, and a gate clock signal GCK2 are provided to a main gate driver 200(m) and the sub gate driver 200(s).

By the above-described configuration, in a left projecting portion 410L and a rectangular portion, a plurality of gate bus lines are sequentially driven one by one by the main gate driver 200(m). In addition, in the right projecting portion 410R, a plurality of gate bus lines are sequentially driven one by one by the sub gate driver 200(s).

<2.4.3 Third Variant>

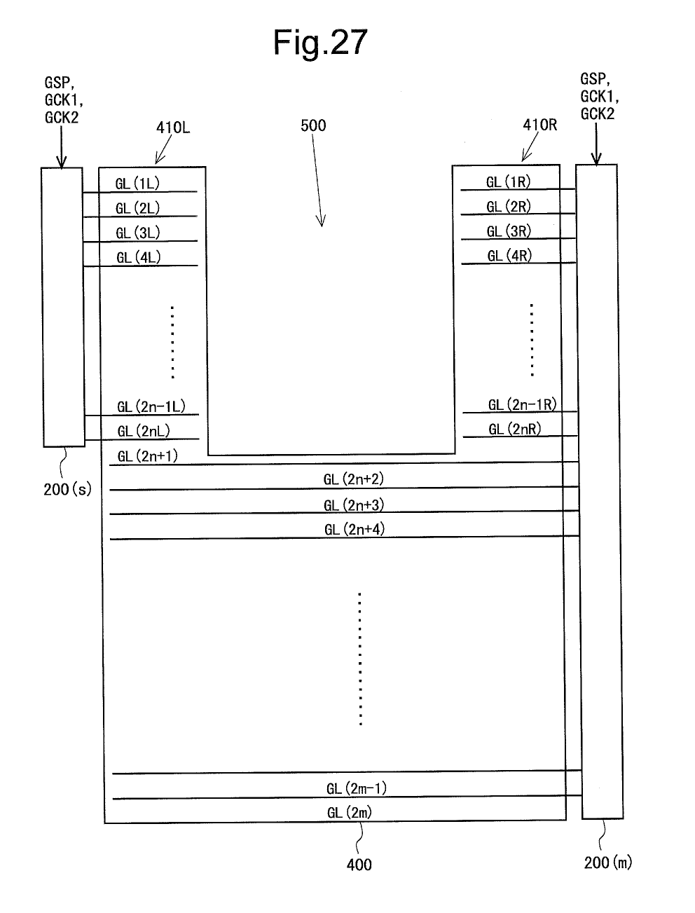

FIG. 27 is a diagram for describing a configuration of a third variant of the second embodiment. As in the second embodiment, a display region 400 has a right-angled U-shape as viewed from the top. In the present variant, unlike the second embodiment, a main gate driver 200(m) is arranged on the right side of the display region 400, and a sub gate driver 200(s) is arranged on the left side of a left projecting portion 410L. As in the second embodiment, a gate start pulse signal GSP, a gate clock signal GCK1, and a gate clock signal GCK2 are provided to the main gate driver 200(m) and the sub gate driver 200(s).

By the above-described configuration, in the left projecting portion 410L, a plurality of gate bus lines are sequentially driven one by one by the sub gate driver 200(s). In addition, in a right projecting portion 410R and a rectangular portion, a plurality of gate bus lines are sequentially driven one by one by the main gate driver 200(m).

### 3. Third Embodiment

A third embodiment of the present invention will be described. Note that the following mainly describes differences from the above-described first embodiment and description of the same respects as those in the first embodiment is omitted.

As a method for driving gate bus lines, staggered driving is adopted in the first embodiment and one-side driving is adopted in the second embodiment. In contrast, in the present embodiment, “both-side driving” is adopted in which each gate bus line GL is driven by both of a gate driver 200 arranged on the left side thereof and a gate driver 200 arranged on the right side thereof. Note that, by adopting such both-side driving, for example, the waveform rounding and delay of a scanning signal at a middle portion can be reduced. A detailed description will be made below.

<3.1 Configuration>

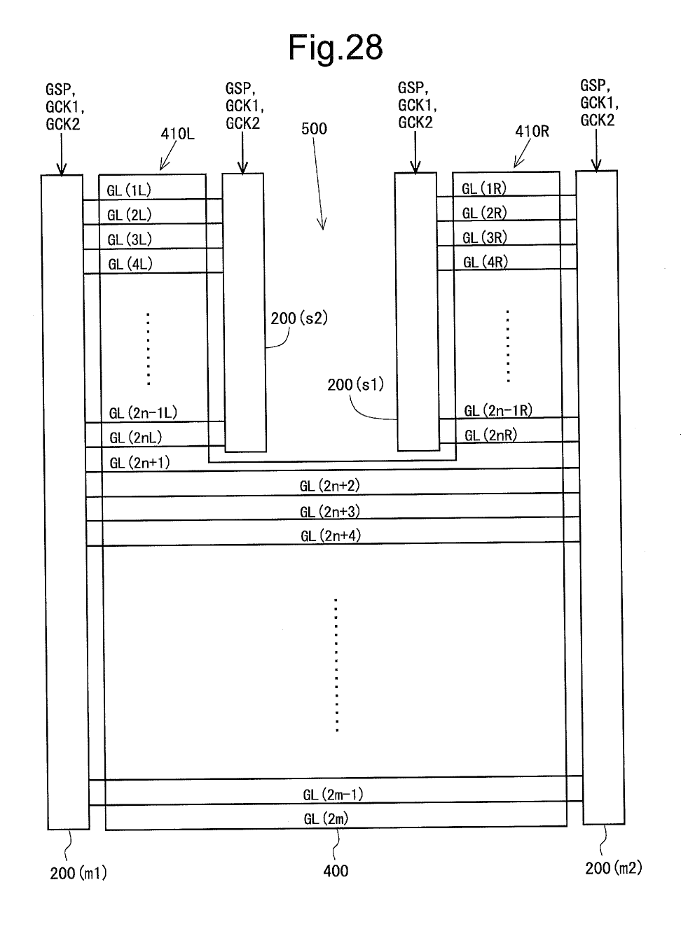

FIG. 28 is a diagram for describing the arrangement of gate drivers 200 of the present embodiment. As can be grasped from FIG. 28, as in the first embodiment, a display region 400 has a right-angled U-shape as viewed from the top. In addition, in the present embodiment, as in the first embodiment, a main gate driver 200(m1) is arranged on the left side of the display region 400, a main gate driver 200(m2) is arranged on the right side of the display region 400, a sub gate driver 200(s1) is arranged on the left side of a right projecting portion 410R, and a sub gate driver 200(s2) is arranged on the right side of a left projecting portion 410L. Note, however, that a connection relationship between the gate drivers and gate bus lines differs from that of the first embodiment. That is, all gate bus lines GL(1L) to GL(2nL) disposed in the left projecting portion 410L are connected to the main gate driver 200(m1) and the sub gate driver 200(s2), and all gate bus lines GL(1R) to GL(2nR) disposed in the right projecting portion 410R are connected to the main gate driver 200(m2) and the sub gate driver 200(s1).

Note that, as in the first embodiment, a first-type scanning signal line drive circuit is implemented by a main gate driver and a second-type scanning signal line drive circuit is implemented by a sub gate driver. Note also that one pair of scanning signal line driving units is implemented by the main gate driver 200(m1) and the sub gate driver 200(s1), and the other pair of scanning signal line driving units is implemented by the main gate driver 200(m2) and the sub gate driver 200(s2). That is, in the present embodiment, two pairs of scanning signal line driving units are provided.

The main gate driver 200(m1) drives the gate bus lines GL(1L) to GL(2nL) and GL(2n+1) to GL(2m). The main gate driver 200(m2) drives the gate bus lines GL(1R) to GL(2nR) and GL(2n+1) to GL(2m). The sub gate driver 200(s1) drives the gate bus lines GL(1R) to GL(2nR). The sub gate driver 200(s2) drives the gate bus lines GL(1L) to GL(2nL).

From the above, each of gate bus lines disposed in the left projecting portion 410L is driven by both the main gate driver 200(m1) arranged on the left side of the relevant gate bus line and the sub gate driver 200(s2) arranged on the right side of the relevant gate bus line. In addition, each of gate bus lines disposed in the right projecting portion 410R is driven by both the sub gate driver 200(s1) arranged on the left side of the relevant gate bus line and the main gate driver 200(m2) arranged on the right side of the relevant gate bus line. Furthermore, each of gate bus lines disposed in a rectangular portion is driven by both the main gate driver 200(m1) arranged on the left side of the relevant gate bus line and the main gate driver 200(m2) arranged on the right side of the relevant gate bus line.

<3.2 Driving Method>

With reference to FIGS. 23, 28, and 29, a driving method of the present embodiment will be described. In the present embodiment, as gate control signals GCTL, one gate start pulse signal GSP and two gate clock signals GCK1 and GCK2 such as those shown in FIG. 23 are used. The gate clock signal GCK1 and the gate clock signal GCK2 are shifted in phase by 180 degrees.

Under the above-described presumption, as shown in FIG. 28, the gate start pulse signal GSP, the gate clock signal GCK1, and the gate clock signal GCK2 are provided to the main gate driver 200(m1), the main gate driver 200(m2), the sub gate driver 200(s1), and the sub gate driver 200(s2). To a shift register circuit (see FIG. 4) 210 included in each gate driver 200 are provided the gate start pulse signal GSP as the above-described gate start pulse signal ST, the gate clock signal GCK1 as the above-described first gate clock signal CK1, and the gate clock signal GCK2 as the above-described second gate clock signal CK2.

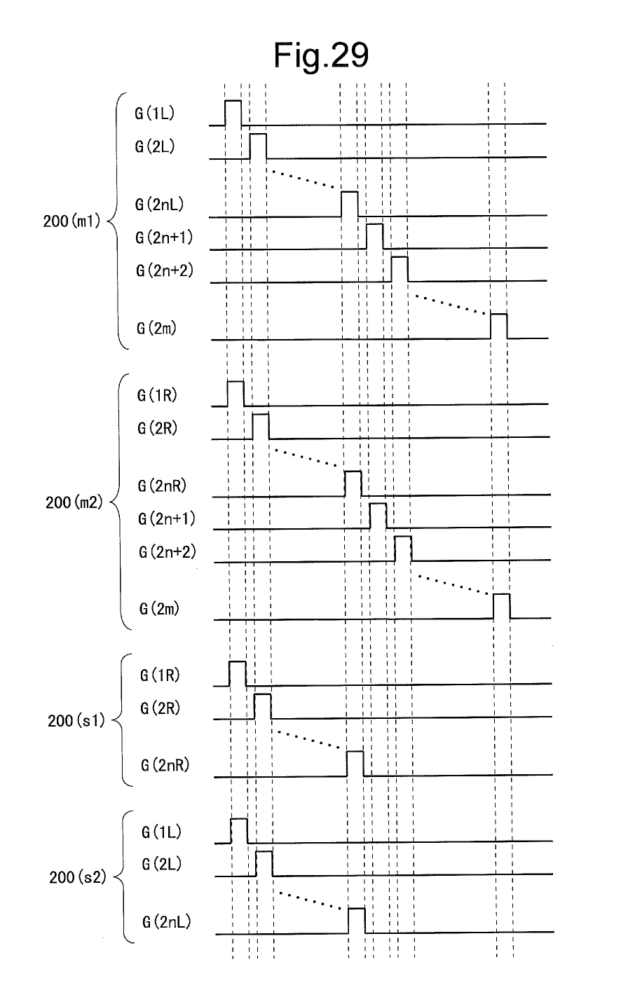

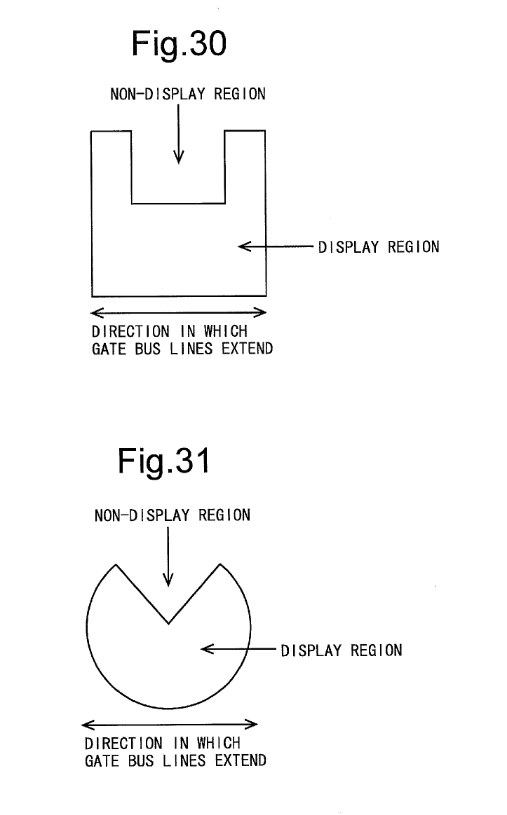

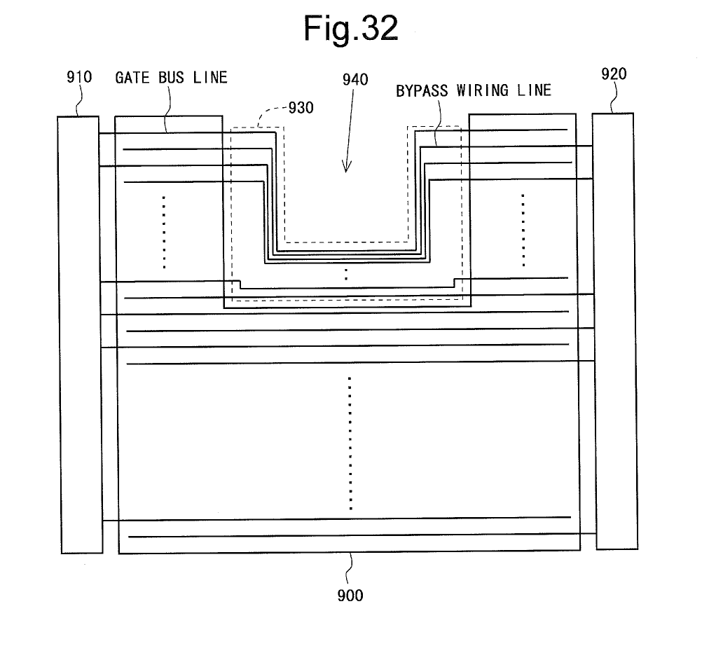

By providing the gate start pulse signal and the gate clock signals to the shift register circuits 210 in the gate drivers 200 in the above-described manner, scanning signals are outputted from each gate driver 200 as shown in FIG. 29. Note that, as in the first embodiment, in FIG. 29, a scanning signal provided to a gate bus line GL( . . . ) (see FIG. 28) is given reference character G( . . . ).

From FIG. 29, the following can be grasped. In the left projecting portion 410L, by sequentially outputting active scanning signals from both the main gate driver 200(m1) and the sub gate driver 200(s2), the gate bus lines GL(1L) to GL(2nL) are sequentially placed in a selected state.

In addition, in the right projecting portion 410R, by sequentially outputting active scanning signals from both the main gate driver 200(m2) and the sub gate driver 200(s1), the gate bus lines GL(1R) to GL(2nR) are sequentially placed in a selected state. Here, a scanning signal G(zL) and a scanning signal G(zR) become active at the same timing (z is an integer between 1 and 2n, inclusive). That is, the scanning start timing of the gate bus lines GL disposed in the left projecting portion 410L is the same as the scanning start timing of the gate bus lines GL disposed in the right projecting portion 410L, and the scanning end timing of the gate bus lines GL disposed in the left projecting portion 410L is the same as the scanning end timing of the gate bus lines GL disposed in the right projecting portion 410L. After the end of scanning of the gate bus lines GL disposed in the left projecting portion 410L and the gate bus lines GL disposed in the right projecting portion 410R, in the rectangular portion, active scanning signals are sequentially outputted from both the main gate driver 200 (m1) and the main gate driver 200(m2). By this, the gate bus lines GL(2n+1) to GL(2m) are sequentially placed in a selected state.

<3.3 Effect>

According to the present embodiment, in a liquid crystal display device having the right-angled U-shaped display region 400 and adopting both-side driving as a driving method, as in the first embodiment, the sub gate drivers are provided in a region where bypass wiring lines for connecting the gate bus lines GL disposed in the left projecting portion 410L to the gate bus lines GL disposed in the right projecting portion 410R are conventionally disposed. By this, even if there are a large number of gate bus lines GL disposed in the left projecting portion 410L and the right projecting portion 410R, the area of a picture-frame region required for the recessed portion 500 can be reduced over conventional displays. As such, as in the first embodiment, a variant-form display (a display device having a right-angled U-shaped display region) achieves a narrower picture-frame than conventional displays.

In addition, since both-side driving is adopted, effects such as those shown below can be obtained. First, the waveform rounding and delay of a scanning signal at a middle portion of each gate bus line GLn can be reduced. In addition, by the reduction in delay, setup time required for timing can be reduced, and thus, the occurrence of erroneous operation of the gate drivers 200 is suppressed.

### 4. Others

Although a liquid crystal display device is described as an example in the above-described embodiments (including the variants), the present invention is not limited thereto. The present invention can also be applied to display devices other than liquid crystal display devices, such as an organic electro luminescence (EL) display device.

In addition, the shape of the display region 400 is not limited to those described in the above-described embodiments (including the variants), and various shapes can be adopted.

This application claims priority to Japanese Patent Application No. 2016-155679, entitled “Display Device”, filed Aug. 8, 2016, the content of which is incorporated herein by reference.

### DESCRIPTION OF REFERENCE CHARACTERS

100: DISPLAY CONTROL CIRCUIT
200: GATE DRIVER
200(m), 200(m1), and 200 (m2): MAIN GATE DRIVER
200(s) and 200(s1) to 200(s4): SUB GATE DRIVER
210: SHIFT REGISTER CIRCUIT
300: SOURCE DRIVER
400: DISPLAY REGION
410L: LEFT PROJECTING PORTION
410R: RIGHT PROJECTING PORTION
500 and 501: RECESSED PORTION
510: HOLE PORTION
520: CUT PORTION
SR: UNIT CIRCUIT
GL: GATE BUS LINE
CK1, CK2, and GCK1 to GCK4: GATE CLOCK SIGNAL
GSP, GSP1, GSP2, and ST: GATE START PULSE SIGNAL

1. A display device having a non-rectangular display region in which scanning signal lines are disposed, the display device comprising:
at least one pair of scanning signal line driving units including a first-type scanning signal line drive circuit configured to drive a relatively large number of scanning signal lines; and a second-type scanning signal line drive circuit configured to drive a relatively small number of scanning signal lines, wherein
regarding the first-type scanning signal line drive circuit and the second-type scanning signal line drive circuit in a pair,
the second-type scanning signal line drive circuit drives scanning signal lines that correspond to some of the scanning signal lines driven by the first-type scanning signal line drive circuit and that are not connected to the scanning signal lines driven by the first-type scanning signal line drive circuit, and
the first-type scanning signal line drive circuit and the second-type scanning signal line drive circuit drive the corresponding scanning signal lines at same timing, based on same timing control signals.

2. The display device according to claim 1, wherein
the display region includes:
a wide-width region in which scanning signal lines extending from one edge to the other edge of the display region are disposed; and
two narrow-width regions in which scanning signal lines with a length corresponding to a length of a part of a distance from one edge to the other edge of the display region are disposed, and
regarding the first-type scanning signal line drive circuit and the second-type scanning signal line drive circuit in a pair,
the first-type scanning signal line drive circuit drives the scanning signal lines disposed in the wide-width region and the scanning signal lines disposed in one of the two narrow-width regions, and
the second-type scanning signal line drive circuit drives the scanning signal lines disposed in the other one of the two narrow-width regions.

3. The display device according to claim 2, wherein
the second-type scanning signal line drive circuit is provided in a non-display region between the two narrow-width regions, and
a width of the second-type scanning signal line drive circuit in a direction in which the scanning signal lines extend is smaller than a width of a bypass wiring line region required when it is assumed that bypass wiring lines are disposed in the non-display region, the bypass wiring lines connecting the scanning signal lines disposed in the two narrow-width regions.

4. The display device according to claim 3, wherein the width of the bypass wiring line region is found by a following equation:
Wr=Wg×2×Nr
where Wr represents the width of the bypass wiring line region, Wg represents a width of one bypass wiring line, and Nr represents a number of the bypass wiring lines for when it is assumed that the bypass wiring lines are disposed.

5. The display device according to claim 2, wherein
bypass wiring lines connecting some of the scanning signal lines disposed in the two narrow-width regions are disposed in a non-display region between the two narrow-width regions, and
the scanning signal lines connected to the bypass wiring lines are driven by the first-type scanning signal line drive circuit.

6. The display device according to claim 5, wherein a width of a bypass wiring line region in which the bypass wiring lines are disposed is smaller than a width of the second-type scanning signal line drive circuit in a direction in which the scanning signal lines extend.

7. The display device according to claim 6, wherein the width of the bypass wiring line region is found by a following equation:
Wr=Wg×2×Nr
where Wr represents the width of the bypass wiring line region, Wg represents a width of one bypass wiring line, and Nr represents a number of the bypass wiring lines disposed in the bypass wiring line region.

8. The display device according to claim 2, wherein the timing control signals are provided to the first-type scanning signal line drive circuit and the second-type scanning signal line drive circuit in a pair, using a same signal wiring line.

9. The display device according to claim 2, wherein the timing control signals are provided to the first-type scanning signal line drive circuit and the second-type scanning signal line drive circuit in a pair, using different signal wiring lines not passing through a non-display region between the two narrow-width regions.

10. The display device according to claim 2, wherein
scanning signal lines earlier in scanning order than the scanning signal lines disposed in the two narrow-width regions are disposed in the wide-width region, and
a scanning signal is provided as a scanning start signal to the second-type scanning signal line drive circuit, the scanning signal being outputted by the first-type scanning signal line drive circuit to a scanning signal line disposed in the wide-width region.

11. The display device according to claim 2, comprising two pairs of scanning signal line driving units, wherein
the scanning signal lines disposed in the wide-width region are alternately driven one by one by a first-type scanning signal line drive circuit included in one of the two pairs of scanning signal line driving units and a first-type scanning signal line drive circuit included in the other one of the two pairs of scanning signal line driving units,
the scanning signal lines disposed in one of the two narrow-width regions are alternately driven one by one by a first-type scanning signal line drive circuit included in one of the two pairs of scanning signal line driving units and a second-type scanning signal line drive circuit included in the other one of the two pairs of scanning signal line driving units, and
the scanning signal lines disposed in the other one of the two narrow-width regions are alternately driven one by one by a second-type scanning signal line drive circuit included in the one of the two pairs of scanning signal line driving units and a first-type scanning signal line drive circuit included in the other one of the two pairs of scanning signal line driving units.

12. The display device according to claim 2, comprising a pair of scanning signal line driving units, wherein
the scanning signal lines disposed in the wide-width region and the scanning signal lines disposed in one of the two narrow-width regions are sequentially driven one by one by the first-type scanning signal line drive circuit, and
the scanning signal lines disposed in the other one of the two narrow-width regions are sequentially driven one by one by the second-type scanning signal line drive circuit.

13. The display device according to claim 2, comprising two pairs of scanning signal line driving units, wherein
the scanning signal lines disposed in the wide-width region are sequentially driven one by one by both of a first-type scanning signal line drive circuit included in one of the two pairs of scanning signal line driving units and a first-type scanning signal line drive circuit included in the other one of the two pairs of scanning signal line driving units,
the scanning signal lines disposed in one of the two narrow-width regions are sequentially driven one by one by both of a first-type scanning signal line drive circuit included in one of the two pairs of scanning signal line driving units and a second-type scanning signal line drive circuit included in the other one of the two pairs of scanning signal line driving units, and
the scanning signal lines disposed in the other one of the two narrow-width regions are sequentially driven one by one by both of a second-type scanning signal line drive circuit included in the one of the two pairs of scanning signal line driving units and a first-type scanning signal line drive circuit included in the other one of the two pairs of scanning signal line driving units.

14. The display device according to claim 1, wherein
the first-type scanning signal line drive circuit and the second-type scanning signal line drive circuit include transistors used to drive the scanning signal lines, and
in each of the scanning signal line drive circuits, the transistors have different sizes depending on wiring line loads of scanning signal lines to be driven.
